(19) United States
(12) Patent Application Publication
(10) Pub. No.: US 2024/0228163 A1
(43) Pub. Date: Jul. 11, 2024

(54) CONVEYANCE SYSTEM, CONVEYANCE METHOD, AND CONVEYANCE VEHICLE USED IN CONVEYANCE SYSTEM

(71) Applicant: Mitsubishi Electric Corporation, Tokyo (JP)

(72) Inventor: Takuya TANIGUCHI, Tokyo (JP)

(73) Assignee: Mitsubishi Electric Corporation, Tokyo (JP)

(21) Appl. No.: 18/509,917

(22) Filed: Nov. 15, 2023

(30) Foreign Application Priority Data
Jan. 11, 2023 (JP) 2023-002034

(51) Int. Cl. B65G 1/04; B65G 43/08

(52) U.S. Cl. CPC B65G 1/0492; B65G 43/08; B65G 2203/0233

(57) ABSTRACT

A conveyance system includes: a travel plan generating unit to generate a travel plan of the conveyance vehicle, the travel plan being used to execute conveyance of the trailer from the parking lot to a platform by the conveyance vehicle or conveyance of the trailer from the platform to the parking lot; and an extraneous vehicle determining unit to determine whether or not the extraneous vehicle is present in the site. When the extraneous vehicle determining unit determines that the extraneous vehicle is present in the site, the travel plan generating unit generates the travel plan in which the conveyance vehicle does not obstruct traveling of the extraneous vehicle. In this case, traveling of the extraneous vehicle such as a truck is not obstructed by the conveyance vehicle, so that operation efficiency of the delivery center can be improved.

### TECHNICAL FIELD

The present disclosure relates to a conveyance system, a conveyance method, and a conveyance vehicle used in the conveyance system.

### BACKGROUND ART

There is a delivery center as a facility serving as a base of transportation and delivery of an article. For example, a truck that tows a trailer loaded with an article enters the delivery center, and the trailer loaded with the article is parked in the site of the delivery center. The article loaded on the trailer is carried into a warehouse provided in the delivery center, and the trailer from which the article is unloaded is parked in the site of the delivery center as an empty trailer. Further, the article carried out from the warehouse is loaded on the empty trailer. Thereafter, the trailer on which the article is loaded is towed by the truck and carried out from the delivery center, whereby the article is transported. As described above, the article is transported using the delivery center as a base.

In order to implement transportation of articles using such a delivery center as a base, it is necessary to convey the trailer from a position where the trailer is parked to a warehouse provided in the delivery center or to convey the trailer from the warehouse to a parking position. Conventionally, a trailer has been conveyed manually using a vehicle driven by a human or a conveyance device such as a trailer dolly. On the other hand, it is required to automatically or semi-automatically convey the trailer using a conveyance vehicle such as an autonomous driving vehicle capable of autonomous traveling.

Regarding a system that assists driving of a vehicle, a system that gives orders of priority to a plurality of vehicles and prioritizes traveling of a vehicle having a higher emergency travel need than a vehicle having a lower emergency travel need is disclosed (See, for example, Patent Literature 1).

### CITATION LIST

### Patent Literatures

Patent Literature 1: US 2019/0043364 A

### SUMMARY OF INVENTION

### Technical Problem

Even in a delivery center in which a conveyance vehicle capable of autonomous traveling and a truck incapable of autonomous traveling are mixed, it is necessary to improve the operation efficiency of the delivery center without obstructing traveling between vehicles. On the other hand, the implementation of the system disclosed in Patent Literature 1 is required to be an autonomous vehicle capable of communication between a vehicle and a vehicle and communication between a communication device provided on a road and the vehicle. However, in a delivery center in which a conveyance vehicle capable of autonomous traveling and a truck incapable of autonomous traveling are mixed, it may be determined by a driver of the truck whether to prioritize traveling of the conveyance vehicle or traveling of the truck. For this reason, in the delivery center, there is a problem that the operation efficiency of the delivery center is reduced when the travel route of the conveyance vehicle and the travel route of the truck interfere with each other.

The present disclosure has been made to solve the above-described problems, and an object of the present disclosure is to provide a conveyance system, a conveyance method, and a conveyance vehicle used in the conveyance system, in which a conveyance vehicle does not obstruct traveling of an extraneous vehicle such as a truck and operation efficiency of a delivery center is improved.

### Solution to Problem

A conveyance system according to the present disclosure is a conveyance system for connecting a conveyance vehicle to a trailer parked in a site of a delivery center and for moving by the conveyance vehicle the trailer either to a warehouse provided in the delivery center or to a parking lot of the delivery center, the conveyance system including: a travel plan generator to generate a travel plan of the conveyance vehicle, the travel plan being used to execute conveyance of the trailer by the conveyance vehicle either from the parking lot to the warehouse or from the warehouse to the parking lot; and an extraneous vehicle determiner to determine whether or not an extraneous vehicle is present in the site, wherein the travel plan generator, when the extraneous vehicle determiner determines that the extraneous vehicle is present in the site, generates the travel plan such that the conveyance vehicle does not obstruct traveling of an extraneous vehicle.

In addition, a conveyance method according to the present disclosure is a conveyance method for connecting a conveyance vehicle to a trailer parked in a site of a delivery center and moving the trailer to a warehouse provided in the delivery center or a parking lot of the delivery center by the conveyance vehicle, the conveyance method including: generating, by a travel plan generating unit, a travel plan of the conveyance vehicle, the travel plan being used to execute conveyance of the trailer from the parking lot to the warehouse by the conveyance vehicle or conveyance of the trailer from the warehouse to the parking lot; and determining, by an extraneous vehicle determining unit, whether or not an extraneous vehicle is present in the site, in which the travel plan generating unit generates the travel plan in which the conveyance vehicle does not obstruct traveling of an extraneous vehicle when the extraneous vehicle determining unit determines that the extraneous vehicle is present in the site.

In addition, a conveyance vehicle according to the present disclosure is a conveyance vehicle used in the conveyance system according to the present disclosure, the conveyance vehicle including a driving control unit to execute driving control on a basis of a travel plan generated by a travel plan generating unit included in the conveyance system.

### Advantageous Effects of Invention

According to the present disclosure, since traveling of an extraneous vehicle such as a truck is not obstructed by the conveyance vehicle, the operation efficiency of the delivery center can be improved.

### BRIEF DESCRIPTION OF DRAWINGS

FIG. 1 is an explanatory diagram illustrating a delivery center according to a first embodiment.

FIG. 2 is an explanatory diagram illustrating an arrangement example of roadside sensors according to the first embodiment.

FIG. 3 is an explanatory diagram illustrating a connection relationship among a control device, a conveyance vehicle, and a roadside sensor according to the first embodiment according to the first embodiment.

FIG. 4 is a configuration diagram illustrating a configuration of the control device according to the first embodiment.

FIG. 5 is a configuration diagram illustrating a configuration of a driving control device provided in the conveyance vehicle according to the first embodiment.

FIG. 6 is an explanatory diagram illustrating a connection operation between the conveyance vehicle and the trailer according to the first embodiment.

FIG. 7 is a flowchart illustrating an operation example of the control device and the driving control device at the time of conveying the trailer according to the first embodiment.

FIG. 8 is an explanatory diagram illustrating an operation example of the conveyance vehicle according to the first embodiment.

FIG. 9 is an explanatory diagram illustrating an operation example of the conveyance vehicle according to the first embodiment.

FIG. 10 is an explanatory diagram illustrating an operation example of the conveyance vehicle according to the first embodiment.

FIG. 11 is an explanatory diagram illustrating an operation example of the conveyance vehicle according to the first embodiment.

FIG. 12 is an explanatory diagram illustrating an operation example of the conveyance vehicle according to the first embodiment.

FIG. 13 is an explanatory diagram illustrating an operation example of the conveyance vehicle according to the first embodiment.

FIG. 14 is an explanatory diagram illustrating an operation example of the conveyance vehicle according to the first embodiment.

FIG. 15 is an explanatory diagram illustrating an operation example of the conveyance vehicle according to the first embodiment.

FIG. 16 is an explanatory diagram illustrating an operation example of the conveyance vehicle according to the first embodiment.

FIG. 17 is an explanatory diagram illustrating an operation example of the conveyance vehicle according to the first embodiment.

FIG. 18 is an explanatory diagram illustrating a part of the configuration of the control device according to the first embodiment.

FIG. 19 is a flowchart illustrating an operation example of the conveyance system according to the first embodiment.

FIG. 20A and FIG. 20B are diagrams illustrating a hardware configuration example of the conveyance system according to the first embodiment.

FIG. 21 is an explanatory diagram illustrating a travel plan generated by a travel plan generating unit according to a second embodiment.

FIG. 22 is an explanatory diagram illustrating a travel plan generated by the travel plan generating unit according to the second embodiment.

FIG. 23 is a flowchart illustrating an operation example of the conveyance system according to the second embodiment.

### DESCRIPTION OF EMBODIMENTS

Hereinafter, embodiments will be described with reference to the drawings. A conveyance system 100 in the present disclosure will be described using an example in which a truck 6 towing a trailer 5 enters a delivery center 1 and the trailer 5 is towed by the truck 6 and exits the delivery center 1, but the conveyance system 100 in the present disclosure can be used in at least one that causes a conveyance vehicle 4 to move the trailer 5. Note that in the present disclosure, transportation and delivery are not distinguished from each other, and they are collectively referred to as delivery. In addition, in the present disclosure, a truck and a tractor are not distinguished, and an extraneous vehicle that tows the trailer 5 is described as a truck.

### First Embodiment

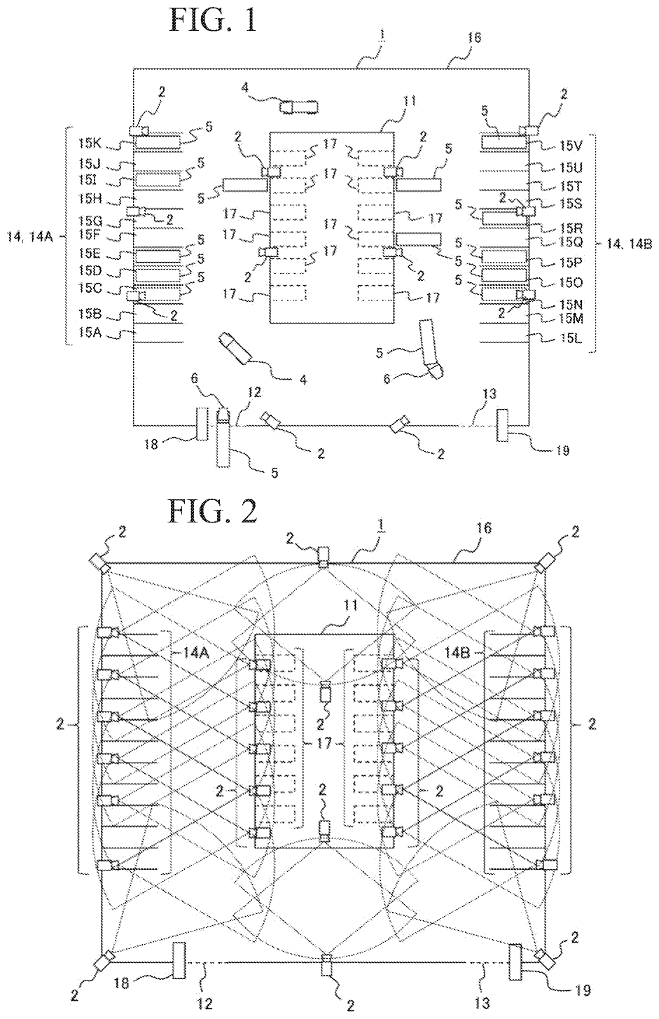

FIG. 1 is an explanatory diagram illustrating a delivery center 1 according to a first embodiment. FIG. 1 is a schematic overhead view of the delivery center 1. The delivery center 1 includes a warehouse 11 in which articles are stored, an entrance 12 and an exit 13 provided for the truck 6 or the like towing the trailer 5 on which the articles are loaded to enter and exit the site of the delivery center 1, and a parking lot 14 provided in the site and being a region where the trailer 5 is parked. In addition, the delivery center 1 is provided with a sensor (hereinafter, referred to as a roadside sensor 2) that is fixed to a structure present in the delivery center 1 and detects at least an object in the site.

The delivery center 1 is surrounded by a fence 16 and the like, and the inside and the outside of the site are partitioned by the fence 16. FIG. 1 illustrates an example in which the delivery center 1 has a rectangular site for easy description, but the site of the delivery center 1 may have any shape.

The warehouse 11 of the delivery center 1 is provided in the site of the delivery center 1, and is disposed, for example, in the center of the site. The warehouse 11 stores articles unloaded from the trailer 5 or articles to be loaded on the trailer 5. The warehouse 11 is provided with one or a plurality of platforms 17, and articles are carried into the warehouse 11 via the platforms 17. In addition, the article stored in the warehouse 11 is carried out via the platform 17 of the warehouse 11 and loaded on the trailer 5 when being a delivery target.

In the example of FIG. 1, the platform 17 on which the article is carried out and the platform 17 on which the article is carried in are illustrated without distinction, but for example, the platform 17 illustrated on the left side in FIG. 1 may be a platform on which the article is carried in, and the platform 17 illustrated on the right side in FIG. 1 may be a platform on which the article is carried out. Note that, although details will be described later, the movement of the trailer 5 is executed by one or a plurality of conveyance vehicles 4 traveling on the site of the delivery center 1.

The entrance 12 of the delivery center 1 is provided to be connected to a road outside the site, and the truck 6 can enter the site from the outside of the site through the entrance 12. In addition, an entrance gate 18 is provided at the entrance 12 of the delivery center 1, and the truck 6 that can enter is managed by a surveillance staff or the like positioned at the entrance gate 18, and entry of an unauthorized truck 6 is restricted. In addition, the driver of the truck 6 entering the delivery center 1 is instructed by the surveillance staff or the like positioned at the entrance gate 18 to indicate a parking space 15 in which the trailer 5 to be parked. Note that the parking space 15 in which the truck 6 parks the trailer 5 may be determined by the control device 3 to be described later.

Similarly to the entrance 12 of the delivery center 1, the exit 13 of the delivery center 1 is provided to be connected to a road outside the site, and the truck 6 can exit from the site to the outside of the site through the exit 13. In addition, an exit gate 19 is provided at the exit 13 of the delivery center 1, and the exiting truck 6 is managed by a surveillance staff or the like positioned at the exit gate 19. Note that, in the example of FIG. 1, the entrance 12 and the exit 13 are provided at different locations, but the entrance 12 and the exit 13 may be provided at the same location.

One or a plurality of parking lots 14 of the delivery center 1 are provided in the site of the delivery center 1, and a plurality of parking spaces 15 are provided in each of the parking lots 14. Each parking space 15 is partitioned by a marker such as a white line, and each parking space 15 has, for example, a width equal to or larger than the vehicle width of the trailer 5 so that the trailer 5 can be parked.

In addition, in the example of FIG. 1, a plurality of parking lots 14 are provided at positions facing the platforms 17 of the warehouse 11. Hereinafter, for the sake of explanation, the parking lot 14 on the left side in FIG. 1 is referred to as a parking lot 14A, and the parking lot 14 on the right side in FIG. 1 is referred to as a parking lot 14B. In addition, the parking space 15 provided in the parking lot 14A is referred to as parking spaces 15A to 15K in order from the lower side in FIG. 1, and the parking space 15 provided in the parking lot 14B is referred to as parking spaces 15L to 15V in order from the lower side in FIG. 1. Note that, in a case where it is not necessary to distinguish the parking lots 14A and 14B, it is simply described as the parking lot 14, and in a case where it is not necessary to distinguish the parking spaces 15A to 15V, it is simply described as the parking space 15.

A trailer 5 on which an article is loaded or an empty trailer 5 on which no article is loaded is parked in the parking space 15. In the example of FIG. 1, the trailers 5 are parked in the parking spaces 15C, 15D, 15E, 15I, 15K, 15N, 15O, 15P, 15R, and 15V, and the parking spaces 15A, 15B, 15F, 15G, 15H, 15J, 15L, 15M, 15Q, 15S, 15T, and 15U are empty spaces on which no trailer 5 is parked. Hereinafter, one or a plurality of parking spaces 15 in which an empty space equal to or larger than the vehicle width of the trailer 5 is secured are referred to as parkable sections. That is, in the example of FIG. 1, the parking spaces 15A, 15B, 15F, 15G, 15H, 15J, 15L, 15M, 15Q, 15S, 15T, and 15U are parkable sections. Note that a plurality of adjacent parkable sections may be one parking section.

The roadside sensor 2 provided in the delivery center 1 includes, for example, at least one of a camera, a sonar, a light detection and ranging (LiDAR), a radio wave sensor, and the like, and detects a moving object including a truck 6, a conveyance vehicle 4, a pedestrian, or the like, an obstacle present in the site of the delivery center 1, and a surrounding feature present in the site of the delivery center 1.

FIG. 2 is an explanatory diagram illustrating an arrangement example of roadside sensors 2 according to the first embodiment. In the example of FIG. 2, the detection range of the roadside sensor 2 is indicated by a broken line. The roadside sensors 2 are fixed to a structure such as a roof of the warehouse 11, the fence 16 of the delivery center 1, or a support provided in the delivery center 1, and a plurality of the roadside sensors 2 are provided in the site of the delivery center 1. The roadside sensor 2 is disposed so as to include at least the parking lot 14 and the platform 17 of the warehouse 11 in a detection range constituted by one or a plurality of roadside sensors 2. In addition, it is preferable that a plurality of roadside sensors 2 are provided so as to include the entire site of the delivery center 1 in the detection range.

The sensor information acquired by the roadside sensor 2 is transmitted to the control device 3 via a communication unit (not illustrated) included in the roadside sensor 2, and is used for generation of a travel plan of the conveyance vehicle 4 to be described later or braking/driving control of the conveyance vehicle 4. However, in the delivery center 1, there are many objects having larger dimensions such as a truck 6 and a trailer 5 as compared with general roads such as public roads. In addition, in the site of the delivery center 1, there is no clear distinction between a section where the truck 6 or the conveyance vehicle 4 can travel and a section where a human such as a worker can move, and there are various mobile objects coming and going.

That is, the environment of the delivery center 1 and the environment of ordinary roads are greatly different in that there are many blind spots and various mobile objects in the delivery center 1. Therefore, in the delivery center 1, it is preferable to arrange a plurality of roadside sensors 2 in order to suppress the occurrence of blind spots of the roadside sensors 2. In the example of FIG. 2, the roadside sensors 2 fixed to the fence 16 or the like of the delivery center 1 and arranged on the parking lot 14 side are arranged, for example, facing the warehouse 11 in such a manner that at least a part of the platform 17 of the warehouse 11 such as one or a plurality of platforms 17 of the warehouse 11 fall within the detection range. On the other hand, the roadside sensors 2 fixed to the roof or the like of the warehouse 11 and arranged on the warehouse 11 side are arranged, for example, facing the parking lot 14 in such a manner that at least a part of the parking lot 14 such as one or a plurality of parking spaces 15 fall within the detection range.

When the roadside sensors 2 are arranged in this manner, an object present in the parking lot 14, an object present in the platform 17, and an object present in the passage between the parking lot 14 and the platform 17 can be detected by the plurality of roadside sensors 2. In addition, since the roadside sensors 2 are arranged to face each other, for example, even if there is generated a region to be a blind spot from the roadside sensors 2 arranged on the parking lot 14 side hidden by the truck 6 when the truck 6 crosses the passage between the parking lot 14 and the warehouse 11, the blind spot is included in the detection range of the roadside sensors 2 arranged on the warehouse 11 side. On the other hand, even if there is generated a region to be a blind spot from the roadside sensors 2 arranged on the warehouse 11 side hidden by the truck 6, the blind spot is included in the detection range of the roadside sensors 2 arranged on the parking lot 14 side.

In addition, for example, even if the trailer 5, the truck 6, or the like is present on a passage on which the conveyance vehicle 4 or the truck 6 travels, and an object is present in a range that is a blind spot from an external sensor 415 to be described later mounted on the conveyance vehicle 4, the object can be detected by the roadside sensors 2. Therefore, in the generation of the travel plan of the conveyance vehicle 4 or the braking/driving control of the conveyance vehicle 4 to be described later, it is possible to prevent collision with an object popping out from a region to be a blind spot from the traveling conveyance vehicle 4. In addition, since the conveyance vehicle 4, the trailer 5, the truck 6, or the worker present in the parking lot 14 or the platform 17 is constantly or intermittently detected, it is possible to generate a travel plan avoiding the parking space 15 and the platform 17 in which the conveyance vehicle 4, the trailer 5, the truck 6, or the worker is present by the control device 3, and to improve the operation efficiency of the delivery center 1.

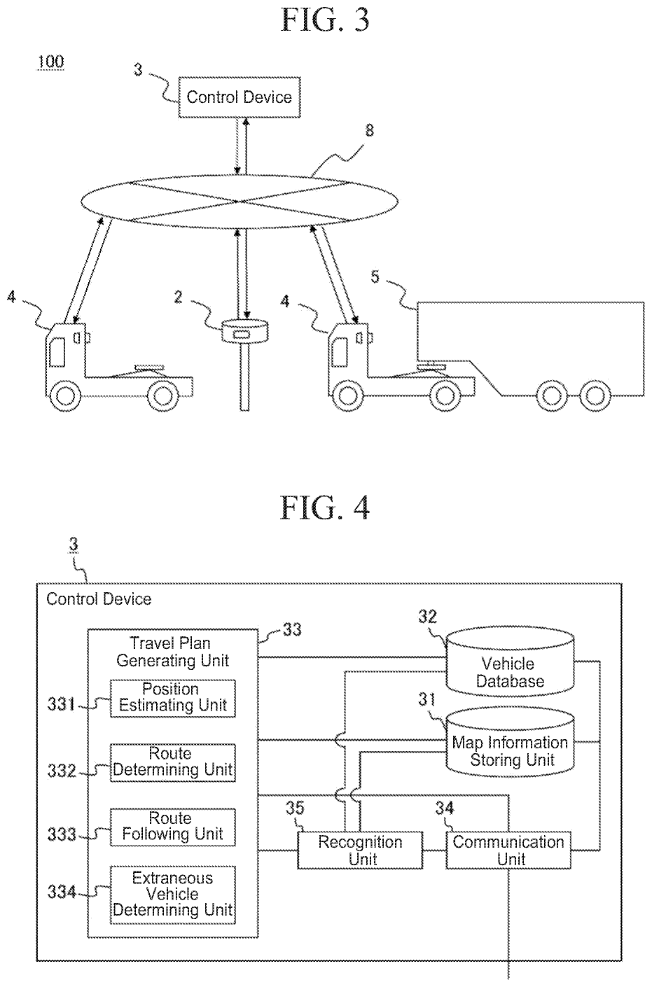

FIG. 3 is an explanatory diagram illustrating a connection relationship among the control device 3, the conveyance vehicle 4, and the roadside sensor 2 according to the first embodiment. The roadside sensor 2 and the conveyance vehicle 4 traveling in the delivery center 1 communicate with the control device 3 via a network 8. Although details will be described later, the control device 3 receives in-vehicle sensor information transmitted from the conveyance vehicle 4 and roadside sensor information transmitted from the roadside sensor 2 via the network 8, and generates a travel plan of the conveyance vehicle 4 using the in-vehicle sensor information and the roadside sensor information. That is, the conveyance system 100 is a system including the control device 3 and the conveyance vehicle 4 in the configuration.

In addition, the control device 3 transmits the travel plan to the conveyance vehicle 4 via the network 8. Then, the conveyance vehicle 4 executes autonomous traveling and conveyance of the trailer 5 on the basis of the received travel plan. Hereinafter, the in-vehicle sensor information transmitted from the conveyance vehicle 4 and the roadside sensor information transmitted from the roadside sensor 2 may be collectively referred to as sensor information. Note that the conveyance vehicle 4 or the roadside sensor 2 may be connected to an edge server (not illustrated) that processes sensor information, and the edge server may be connected to the control device 3 via the network 8.

The control device 3 will be described. FIG. 4 is a configuration diagram illustrating a configuration of the control device 3 according to the first embodiment. The control device 3 includes a map information storing unit 31 to store map information of the delivery center 1, a vehicle database 32 that is a database capable of storing information of the conveyance vehicle 4 and the trailer 5 present in the delivery center 1, a travel plan generating unit 33 to generate a travel plan used for autonomous traveling of the conveyance vehicle 4, a communication unit 34 to communicate with the roadside sensor 2 and the conveyance vehicle 4, and a recognition unit 35 to generate peripheral recognition information for recognizing the environment in the site of the delivery center 1. Further, an extraneous vehicle determining unit 334 illustrated in FIG. 4 will be described later in detail. Note that at least one of the map information storing unit 31, the vehicle database 32, the travel plan generating unit 33, the communication unit 34, and the recognition unit 35 included in the control device 3 may be provided in the edge server. That is, for example, the recognition unit 35 may be provided in the edge server, and the edge server may transmit the peripheral recognition information to the control device 3.

The map information stored in the map information storing unit 31 is a highly accurate basic map used for autonomous traveling. In addition, the map information includes, for example, a passage present in the site of the delivery center 1, a connection relationship of the passage, a width and a length of the passage, a road surface of the passage, position information of surrounding features such as the warehouse 11 of the delivery center 1, and the like. Note that the map information may be configured from a highly accurate three-dimensional map reflecting position information and the like of surrounding features and obstacles. The highly accurate three-dimensional map may be configured by, for example, a three-dimensional model of a point group, a line segment, a feature, and the like expressed using highly accurate three-dimensional position coordinates of a centimeter class to a submeter class according to a reference coordinate system such as a world geodetic system (WGS) or a geodetic system.

The vehicle database 32 is a database that stores information of the plurality of conveyance vehicles 4 managed by the control device 3. The vehicle database 32 stores, for example, an ID of the conveyance vehicle 4 and a state such as whether or not the conveyance vehicle 4 is executing the conveyance of the trailer 5. In addition, the vehicle database 32 stores information such as a parking position of the trailer 5, a type of the trailer 5, a dimension of the trailer 5, whether or not to load an article, an entry date and time, and an exit date and time as information of the trailer 5 present in the delivery center 1.

The recognition unit 35 generates peripheral recognition information for recognizing the environment in the site of the delivery center 1 on the basis of the sensor information of the in-vehicle sensor and the roadside sensor 2 acquired via the communication unit 34. Here, the environment in the site of the delivery center 1 refers to the presence or absence of an object in the site of the delivery center 1. That is, the peripheral recognition information generated by the recognition unit 35 includes position information indicating the parking position and the parkable region of the trailer 5 present in the delivery center 1.

In addition, the sensor information transmitted from the in-vehicle sensor includes information sensed by the external sensor 415 that is provided in the conveyance vehicle 4 and senses the environment around the conveyance vehicle 4. The sensor information transmitted from the in-vehicle sensor may include position information acquired by a GPS receiver 414 of the conveyance vehicle 4. Further, when a vehicle posture sensor, a weight sensor, or the like is provided in the conveyance vehicle 4, the sensor information transmitted from the in-vehicle sensor may include information such as the vehicle posture and the in-vehicle weight of the conveyance vehicle 4. That is, the in-vehicle sensor may include not only the external sensor 415 but also other sensors mounted on the conveyance vehicle 4.

The travel plan generating unit 33 generates a travel plan of the conveyance vehicle 4 so that the conveyance vehicle 4 autonomously travels on the travel route on the basis of the map information and the sensor information transmitted from the conveyance vehicle 4 and the roadside sensor 2.

The travel plan generating unit 33 includes a position estimating unit 331. The position estimating unit 331 estimates the conveyance vehicle position information including the position of the conveyance vehicle 4 and the direction in which the conveyance vehicle 4 is facing on the basis of the map information and the sensor information. Specifically, the position estimating unit 331 estimates the conveyance vehicle position information on the basis of the peripheral recognition information and the map information.

The travel plan generating unit 33 includes a route determining unit 332. The route determining unit 332 generates a travel route of the conveyance vehicle 4 on the basis of the map information, the conveyance vehicle position information, and the peripheral recognition information. In addition, when the travel plan generating unit 33 generates a travel plan for causing the conveyance vehicle 4 to travel toward the trailer 5 or the parking space 15 for conveyance of the trailer 5, the travel plan generating unit 33 generates the travel route of the conveyance vehicle 4 on the basis of the map information, the conveyance vehicle position information, the peripheral recognition information, and the position information of the trailer 5 to be conveyed or the parking space 15 for parking the trailer 5.

That is, when the conveyance vehicle 4 is caused to execute conveyance of the trailer 5, the travel route includes a position where the trailer 5 to be conveyed is to be parked (hereinafter, referred to as a first parking position) and a position where the trailer 5 to be conveyed is parked (hereinafter, referred to as a second parking position). Note that the first parking position is, for example, the parking space 15 or the platform 17 of the warehouse 11, and the second parking position is the parkable section or the platform 17 of the warehouse 11.

Here, the travel route is represented, for example, by dividing a route from the current position of the conveyance vehicle 4 to a target position into a plurality of routes. That is, the travel route includes, for example, a plurality of points present up to the target position, and the plurality of points are set as points through which the conveyance vehicle 4 should pass.

The travel plan generating unit 33 includes a route following unit 333. The route following unit 333 generates control information including speed control information for controlling the speed of the conveyance vehicle 4 and direction control information for controlling the steering angle of the conveyance vehicle 4 on the basis of the travel route and the conveyance vehicle position information. Then, the travel plan generating unit 33 transmits the travel plan to the conveyance vehicle 4 via the communication unit 34.

That is, the travel plan generated by the travel plan generating unit 33 includes the travel route of the conveyance vehicle 4 and control information for the conveyance vehicle 4 to travel on the travel route. Note that the speed indicates the speed of the conveyance vehicle 4, and the steering angle indicates the traveling direction of the conveyance vehicle 4. The speed and the steering angle can be rephrased as a speed and a steering angle, or a speed and a traveling direction. Here, the travel plan transmitted from the travel plan generating unit 33 does not need to include the control information. In this case, a driving control unit 411 of the driving control device 41 to be described later may generate the control information so as to follow the travel route generated by the travel plan generating unit 33. When the driving control unit 411 generates the control information, the route following unit 333 of the control device 3 can be appropriately omitted.

In addition, the travel plan generating unit 33 generates the travel plan for each conveyance vehicle 4. In the case of generating the travel plan for the plurality of conveyance vehicles 4, when the travel plan is generated by the travel plan generating unit 33 so that the plurality of conveyance vehicles 4 do not interfere with each other, for example, by generating the travel plans of the plurality of conveyance vehicles 4 so that the travel route of one conveyance vehicle 4 and the travel route of the other conveyance vehicle 4 do not intersect, the operation efficiency of the delivery center 1 is improved because the plurality of conveyance vehicles 4 do not interfere with each other.

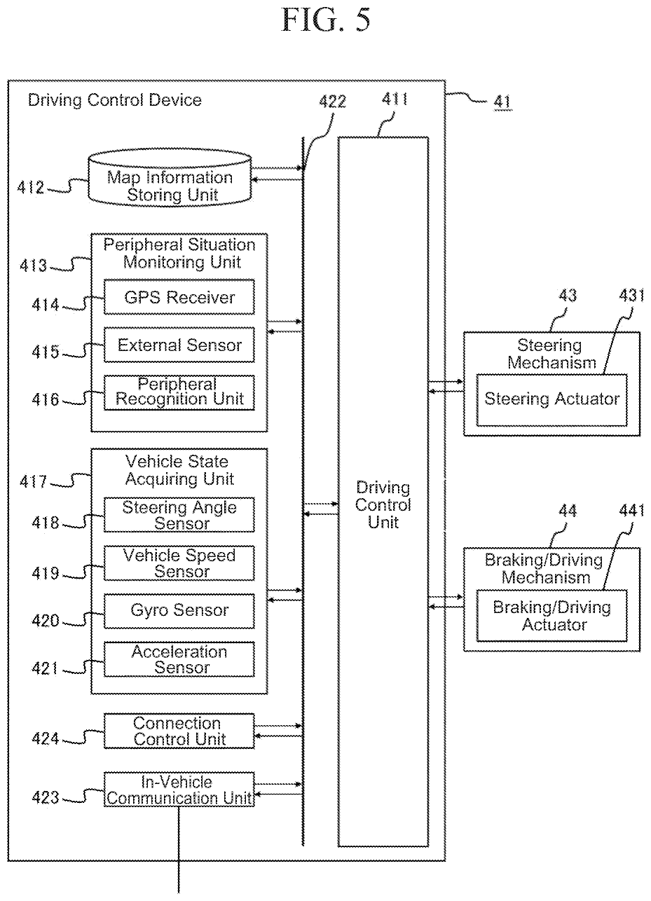

Next, a configuration of the conveyance vehicle 4 will be described. FIG. 5 is a configuration diagram illustrating a configuration of the driving control device 41 provided in the conveyance vehicle 4 according to the first embodiment. The driving control device 41 includes the driving control unit 411 that controls the steering mechanism 43 and the braking/driving mechanism 44 of the conveyance vehicle 4 to perform driving control of the conveyance vehicle 4 on the basis of the travel plan received from the control device 3. In addition, the driving control device 41 includes a map information storing unit 412 that stores map information used for autonomous traveling of the conveyance vehicle 4, a peripheral situation monitoring unit 413 that monitors a peripheral situation of the conveyance vehicle 4, a vehicle state acquiring unit 417 that acquires information indicating a state of the conveyance vehicle 4 on which the driving control device 41 is mounted, an in-vehicle communication unit 423 configured to be capable of wireless communication, and a connection control unit 424 that controls connection and disconnection of the trailer 5 and the conveyance vehicle 4.

Note that the driving control unit 411, the map information storing unit 412, the peripheral situation monitoring unit 413, and the vehicle state acquiring unit 417 included in the driving control device 41 are each connected to a communication bus 422 included in the driving control device 41, and can transmit and receive data via the communication bus 422.

The steering mechanism 43 is a mechanism provided in the conveyance vehicle 4 to determine the traveling direction of the conveyance vehicle 4, and includes, for example, a steering wheel, a steering shaft, a rack, a pinion, a steering actuator 431, and the like. The braking/driving mechanism 44 is a mechanism for controlling the traveling speed and switching between forward movement and backward movement of the conveyance vehicle 4, and includes, for example, a driving device such as an engine and a motor, an accelerator, a brake, a shift, a braking/driving actuator 441, and the like. Note that the steering actuator 431 that controls the steering mechanism 43 includes, for example, an electric power steering (EPS) motor and the like, and the braking/driving actuator 441 that controls the braking/driving mechanism 44 includes, for example, an electronically controlled throttle, a brake actuator, and the like. In addition, when the conveyance vehicle 4 performs only autonomous traveling, a mechanism based on human operation such as a steering wheel, an accelerator, and a brake is not essential and can be appropriately omitted.

The map information storing unit 412 stores map information. The map information stored in the map information storing unit 31 is a highly accurate basic map used for autonomous traveling, similarly to the map information stored in the map information storing unit 31 included in the control device 3. In addition, the map information includes, for example, a passage present in the site of the delivery center 1, a connection relationship of the passage, a width and a length of the passage, a road surface of the passage, position information of surrounding features such as the warehouse 11 of the delivery center 1, and the like. Note that the map information may be configured from a highly accurate three-dimensional map capable of indicating a passage through which the conveyance vehicle 4 or the like can pass, a road surface of the passage, and surrounding features. In addition, the map information stored in the map information storing unit 412 may be updated by map information or the like which is delivered from the control device 3 and in which the position information of the trailer 5 is reflected.

When the control device 3 includes the map information storing unit 31, the conveyance vehicle 4 can autonomously travel even if the driving control device 41 does not include the map information storing unit 412. When the driving control device 41 includes the map information storing unit 412, the conveyance vehicle 4 can autonomously travel even if the control device 3 does not include the map information storing unit 31. That is, the map information may be stored in at least one of the map information storing unit 31 provided in the control device 3 or the map information storing unit 412 provided in the driving control device 41.

The peripheral situation monitoring unit 413 is configured to be able to monitor the situation around the host vehicle, and includes a global positioning system (GPS) receiver 414, an external sensor 415, and a peripheral recognition unit 416.

The GPS receiver 414 receives a signal transmitted from a GPS positioning satellite, and detects the current position of the conveyance vehicle 4 as conveyance vehicle position information. Note that the driving control device 41 may include a global navigation satellite system (GNSS) receiver in addition to the GPS receiver 414, and the driving control device 41 may include a GNSS receiver instead of the GPS receiver 414.

The external sensor 415 is configured by, for example, at least one of a camera that images the outside of the vehicle, a sonar, a LiDAR, a radio wave sensor, and the like, and detects the position of another vehicle, a pedestrian, an obstacle, or the like present around the conveyance vehicle 4, the distance from the host vehicle, or the like.

The peripheral recognition unit 416 recognizes the environment around the host vehicle on the basis of the conveyance vehicle position information and the sensor information of the conveyance vehicle 4 acquired from the GPS receiver 414 and the external sensor 415. Here, the environment around the host vehicle indicates, for example, the presence or absence of an object around the host vehicle such as the detection range of the external sensor 415.

The in-vehicle communication unit 423 is, for example, a wireless communication device connected to an antenna for wireless communication. The in-vehicle communication unit 423 communicates with an in-vehicle communication unit provided in another conveyance vehicle 4, a communication unit installed on a road, or the like to acquire information on the position of another vehicle or a pedestrian, or the like.

In addition, the in-vehicle communication unit 423 can perform communication between the vehicle and the vehicle by wireless communication, that is, inter-vehicle communication with the in-vehicle communication unit 423 of another vehicle present around the host vehicle. Note that the in-vehicle communication unit 423 can output information received from another vehicle to the communication bus 422. Further, the in-vehicle communication unit 423 may be configured to be able to acquire information from the roadside sensor 2.

Furthermore, the in-vehicle communication unit 423 is configured to be able to transmit the information generated by the driving control device 41 and output to the communication bus 422 to the control device 3 and another vehicle. That is, the sensor information transmitted from the conveyance vehicle 4 to the control device 3 may include conveyance vehicle position information, a speed, a steering angle, or the like in addition to the sensor information acquired by the external sensor 415.

The vehicle state acquiring unit 417 acquires information indicating the state of the host vehicle, and includes a steering angle sensor 418, a vehicle speed sensor 419, a gyro sensor 420, and an acceleration sensor 421.

The steering angle sensor 418 is provided in, for example, an EPS motor or a steering wheel, and detects a steering angle of the host vehicle. The vehicle speed sensor 419 is provided on a wheel, for example, and detects a traveling speed of the host vehicle.

The gyro sensor 420 is a sensor that detects an angular velocity in an azimuth direction when the conveyance vehicle 4 turns. The acceleration sensor 421 is a sensor that detects acceleration in the front-rear direction (for example, in the vehicle length direction), the left-right direction (for example, in the vehicle width direction), and the up-down direction (for example, in the vehicle height direction) of the conveyance vehicle 4. Even when the position information of the conveyance vehicle 4 cannot be acquired from the GPS receiver 414 or the like, the position of the conveyance vehicle 4 can be estimated using the angular velocity and the acceleration in each direction acquired by the gyro sensor 420 and the acceleration sensor 421.

The driving control unit 411 of the driving control device 41 controls the steering actuator 431 or the braking/driving actuator 441 mounted on the host vehicle to execute autonomous traveling. The driving control unit 411 performs driving control of the host vehicle by outputting a signal to the steering actuator 431, the braking/driving actuator 441, or the like, for example.

The driving control unit 411 controls the braking/driving actuator 441 configured by, for example, an electronically controlled throttle, a brake actuator, and the like to perform braking/driving control of the host vehicle such as operating the brake to decelerate or stop the host vehicle. The driving control unit 411 controls the steering actuator 431 including, for example, an EPS motor and performs steering control of the host vehicle such as maintaining a travel route on which the host vehicle travels.

That is, the driving control unit 411 generates control information and controls the steering actuator 431 and the braking/driving actuator 441 so as to follow the travel route included in the travel plan received from the control device 3, thereby implementing the autonomous traveling of the conveyance vehicle 4 based on the travel plan. In addition, the driving control unit 411 may control the steering actuator 431 and the braking/driving actuator 441 using the control information included in the travel plan so as to follow the travel route included in the travel plan received from the control device 3, thereby implementing autonomous traveling of the conveyance vehicle 4 based on the travel plan. Note that, when the conveyance vehicle 4 is configured to be able to be driven by a person, a display device (not illustrated) may be provided in the conveyance vehicle 4, and the travel route included in the travel plan received from the control device 3 may be displayed on the display device to enable traveling of the conveyance vehicle 4 based on the travel plan.

In addition, when the external sensor 415 mounted on the conveyance vehicle 4 detects the presence of an obstacle in the travel route and determines that there is a risk of contact between the conveyance vehicle 4 and the obstacle, the driving control unit 411 executes emergency stop control for automatically stopping the conveyance vehicle 4. When the emergency stop control is started, the driving control unit 411 stops the conveyance vehicle 4 on the spot. In addition, when executing the emergency stop control, the driving control unit 411 may cause the peripheral situation monitoring unit 413 to search for an evacuation place where the host vehicle is stopped, and move the conveyance vehicle 4 to the evacuation place to stop the conveyance vehicle 4. Note that the above-described evacuation place is preferably a position that does not obstruct movement of other mobile objects such as the truck 6, such as a standby place described later. In addition, the control for avoiding the contact with the obstacle by the driving control unit 411 is preferably executed in preference to the travel plan generated by the travel plan generating unit 33. In this way, when there is a risk of collision of the conveyance vehicle 4 with an obstacle, avoidance of the obstacle can be promptly executed.

The connection control unit 424 lifts and lowers a fifth wheel 45 provided on a pedestal or the like of the conveyance vehicle 4, and executes connection or disconnection of the conveyance vehicle 4 and the trailer 5. The connection control unit 424 transmits a signal to a lift 46 provided in the conveyance vehicle 4 to drive the lift 46, thereby executing lifting and lowering of the fifth wheel 45.

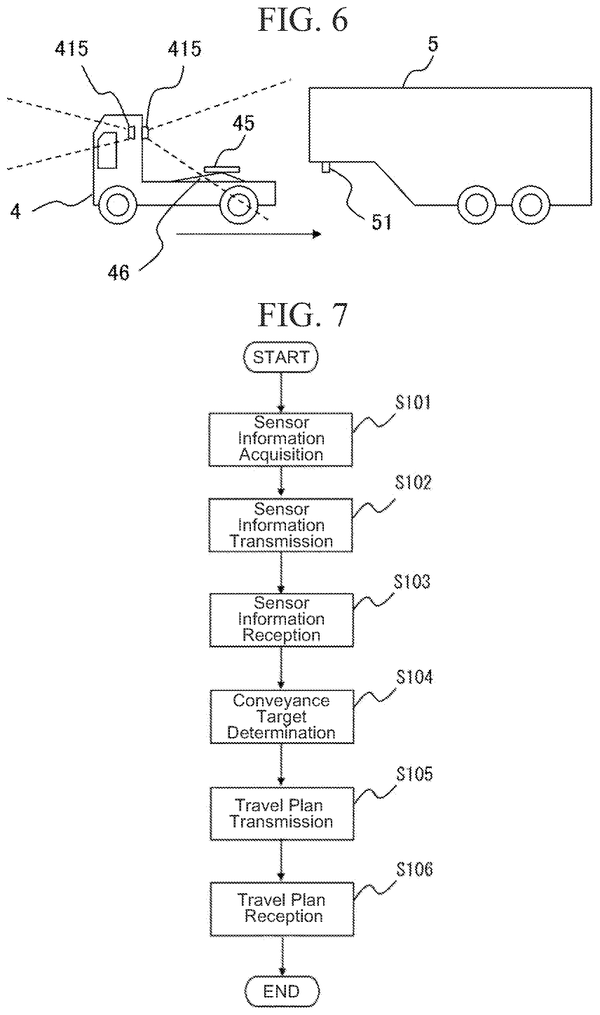

The connection and disconnection of the conveyance vehicle 4 and the trailer 5 will be described. FIG. 6 is an explanatory diagram illustrating a connection operation between the conveyance vehicle 4 and the trailer 5 according to the first embodiment. When connection with the trailer 5 is executed, the conveyance vehicle 4 approaches the trailer 5 to be conveyed on the basis of the travel plan. Next, under the driving control of the driving control unit 411, the conveyance vehicle 4 executes direction change as necessary so that the pedestal provided with the fifth wheel 45 faces the direction in which the trailer 5 is disposed, and moves to a position where a king pin 51 provided at the lower portion of the trailer 5 and the fifth wheel 45 can be engaged with each other. Note that, in the example of FIG. 6, the pedestal of the conveyance vehicle 4 extends toward the rear side (the right side in FIG. 6) of the conveyance vehicle 4, and the fifth wheel 45 is provided on the pedestal. That is, in the example of FIG. 6, the conveyance vehicle 4 moves backward and approaches the trailer 5. Then, the connection control unit 424 of the conveyance vehicle 4 drives the lift 46 to raise the fifth wheel 45, engages the fifth wheel 45 with the king pin 51, and completes the connection between the conveyance vehicle 4 and the trailer 5.

In the connection operation between the conveyance vehicle 4 and the trailer 5 described above, the conveyance vehicle 4 needs to approach the trailer 5, but when the conveyance vehicle 4 and the trailer 5 approach each other, the space between the conveyance vehicle 4 and the trailer 5 may be a blind spot of an external sensor 415 mounted on another conveyance vehicle 4 or a blind spot of a roadside sensor 2. Therefore, the driving control unit 411 preferably executes the driving control of the conveyance vehicle 4 to be connected to the trailer 5 using the sensor information acquired by the external sensor 415 provided in the conveyance vehicle 4 to be connected to the trailer 5.

In addition, in the case of disconnecting the conveyance vehicle 4 and the trailer 5, the conveyance vehicle 4 moves the trailer 5 to the parking position, and then drives the lift 46 by the connection control unit 424 to lower the fifth wheel 45, thereby completing the disconnecting of the conveyance vehicle 4 and the trailer 5. Note that, when it is necessary to connect an air pressure line for supplying air pressure from the conveyance vehicle 4, a cable for supplying electric power from the conveyance vehicle 4, or the like to the trailer 5, a robot having a manipulator may be mounted on a pedestal of the conveyance vehicle 4, and the connection of the air pressure line, the cable, or the like may be automatically executed by the robot. Even in a case where an air pressure line for supplying air pressure from the conveyance vehicle 4, a cable for supplying electric power from the conveyance vehicle 4, or the like is detached from the trailer 5, the detachment may be automatically executed by the above-described robot. In this case, a signal indicating that the connection or disconnection between the conveyance vehicle 4 and the trailer 5 is finished or started may be transmitted by the in-vehicle communication unit 423 to a control device (not illustrated) that controls the robot, and the robot may connect or detach the cable or the like.

Next, operations of the control device 3 and the driving control device 41 will be described. FIG. 7 is a flowchart illustrating an operation example of the control device 3 and the driving control device 41 at the time of conveying the trailer 5 according to the first embodiment.

In step S101, the external sensor 415 of the conveyance vehicle 4 or the roadside sensor 2 acquires sensor information. Specifically, the external sensor 415 or the roadside sensor 2 configured by a camera, a sonar, a radio wave sensor, a LiDAR, or the like senses the site of the delivery center 1.

In step S102, the communication unit of the roadside sensor 2 or the in-vehicle communication unit 423 of the conveyance vehicle 4 transmits sensor information obtained by sensing to the control device 3.

In step S103, the communication unit 34 of the control device 3 receives sensor information from the roadside sensor 2 and the conveyance vehicle 4. Note that step S101, step S102, and step S103 may be repeatedly executed.

Then, in step S104, the travel plan generating unit 33 of the control device 3 determines the trailer 5 to be conveyed. That is, the travel plan generating unit 33 specifies a first parking position where the trailer 5 to be conveyed is parked and a second parking position where the trailer 5 to be conveyed is parked.

Note that the trailer 5 to be conveyed may be determined on the basis of the recognition result of the recognition unit 35 or may be determined by the administrator of the delivery center 1 who operates the control device 3 via the user interface. In the case of determining the trailer 5 to be conveyed on the basis of the recognition result of the recognition unit 35, for example, when the recognition unit 35 detects the trailer 5 parked in the parking lot 14 and the platform 17 on which no other trailer 5 or the like is present, the travel plan generating unit 33 determines the trailer 5 parked in the parking lot 14 as the conveyance target. In addition, for example, when the recognition unit 35 detects the trailer 5 parked on the platform 17 after the loading or unloading work of the article is completed and the parkable section, the travel plan generating unit 33 determines the trailer 5 parked on the platform 17 as the conveyance target.

In step S105, the travel plan generating unit 33 generates a travel plan and transmits the travel plan to the conveyance vehicle 4 via the communication unit 34. Specifically, the recognition unit 35 of the control device 3 generates peripheral recognition information for recognizing the surroundings of the conveyance vehicle 4 on the basis of the sensor information received in step S103.

Here, the conveyance vehicle 4 for which the travel plan generating unit 33 is to generate the travel plan may be the conveyance vehicle 4 that is not engaged in the conveyance of the trailer 5 or completes the conveyance of the trailer 5 after a predetermined time has elapsed, among the plurality of conveyance vehicles 4. Information regarding the operation state of the conveyance vehicle 4, such as whether or not each of the conveyance vehicles 4 is engaged in the conveyance of the trailer 5 or the time when the conveyance of the trailer 5 ends, is stored in the vehicle database 32 of the control device 3. Note that, for example, information indicating whether or not each of the conveyance vehicles 4 is engaged in the conveyance of the trailer 5 may be stored in the vehicle database 32 using a signal acquired by the control device 3 from the driving control unit 411 and indicating that the conveyance vehicle 4 has started or ended the conveyance of the trailer 5. Further, for example, on the basis of the travel plan generated by the travel plan generating unit 33, the travel plan generating unit 33 may estimate time when the conveyance of the trailer 5 ends, and the time may be used as the information on the operation state of the conveyance vehicle 4. In addition, the control device 3 may acquire information on whether the conveyance vehicle 4 is connected to or disconnected from the trailer 5 from the connection control unit 424 of the driving control device 41, and store the information in the vehicle database 32 as information on the operation state of the conveyance vehicle 4.

The position estimating unit 331 of the travel plan generating unit 33 estimates the conveyance vehicle position information on the basis of the recognition information and the map information. For example, the position estimating unit 331 estimates the conveyance vehicle position information using a simultaneous localization and mapping (SLAM) technology that simultaneously estimates the position of the conveyance vehicle 4 and creates an environmental map. Further, in addition to the SLAM technology, by using the position information by the GPS included in the sensor information transmitted from the conveyance vehicle 4, the conveyance vehicle position information can be estimated more accurately.

Then, the travel plan generating unit 33 generates a travel plan and transmits the travel plan to the conveyance vehicle 4 via the communication unit 34. Specifically, the route determining unit 332 of the travel plan generating unit 33 generates the travel route of the conveyance vehicle 4 on the basis of the map information, the conveyance vehicle position information, and the peripheral recognition information.

Next, the route following unit 333 of the travel plan generating unit 33 generates control information including speed control information for controlling the speed of the conveyance vehicle 4 and direction control information for controlling the steering angle of the conveyance vehicle 4 on the basis of the travel route and the conveyance vehicle position information. Then, the communication unit 34 of the control device 3 transmits the travel plan to the conveyance vehicle 4.

In step S106, the in-vehicle communication unit 423 of the conveyance vehicle 4 receives the travel plan. Then, the travel plan is input to the driving control unit 411. Here, the driving control unit 411 of the conveyance vehicle 4 may generate a signal indicating that the conveyance of the trailer 5 has started and transmit the signal to the control device 3 via the in-vehicle communication unit 423. Note that, when the control information is not included in the travel plan transmitted from the travel plan generating unit 33, the driving control unit 411 of the driving control device 41 may generate the control information so that the conveyance vehicle 4 follows the travel route.

The driving control unit 411 controls the speed and the steering angle on the basis of the travel plan. As a result, the conveyance vehicle 4 autonomously travels on the travel route on the basis of the travel plan. The conveyance vehicle 4 moves to the first parking position on the basis of the travel plan, and is connected to the trailer 5 to be conveyed present at the first parking position. Then, after conveying the trailer 5 to the second parking position, the conveyance vehicle 4 disconnects the trailer 5 and parks the trailer 5 at the second parking position. Here, the driving control unit 411 of the conveyance vehicle 4 may generate a signal indicating that the conveyance of the trailer 5 has ended, and transmit the signal to the control device 3 via the in-vehicle communication unit 423.

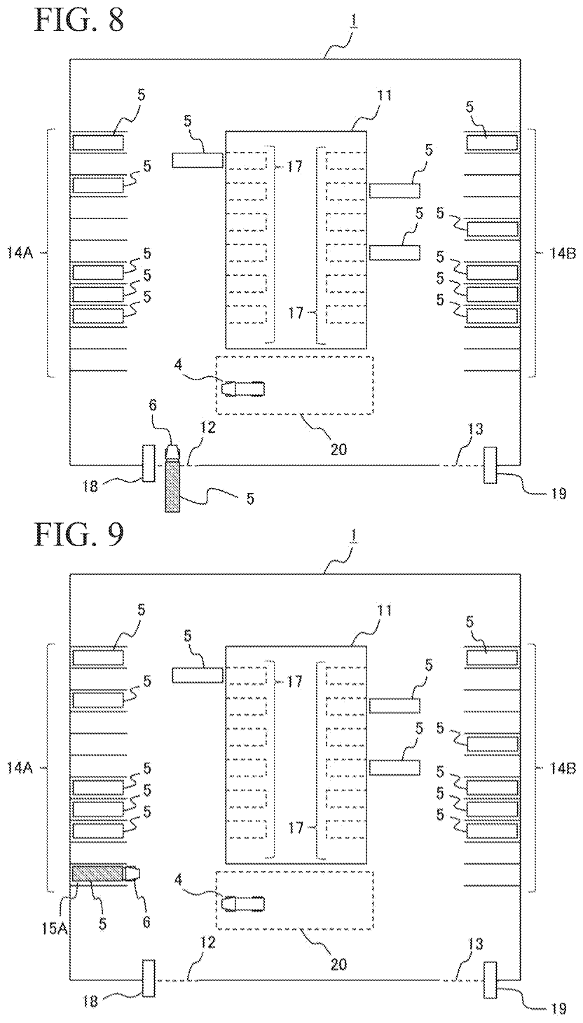

An operation of the conveyance vehicle 4 related to entry of the truck 6 towing the trailer 5 and conveyance of the trailer 5 to the warehouse 11 by the conveyance vehicle 4 will be described. FIGS. 8 to 13 are explanatory diagrams illustrating an operation example of the conveyance vehicle 4 according to the first embodiment. In FIGS. 8 to 13, the roadside sensor 2 is not illustrated for simplicity. In addition, the trailer 5 to be conveyed by the conveyance target 4 is hatched.

The entry of the truck 6 towing the trailer 5 will be described with reference to FIG. 8. The truck 6 towing the trailer 5 enters the site of the delivery center 1 from the entrance 12 of the delivery center 1. When the surveillance staff at the entrance gate 18 permits the driver of the truck 6 to enter the delivery center 1, the parking space 15 for parking the trailer 5 is designated. Note that, the surveillance staff may instruct the driver of the truck 6 about the parking space 15 for parking the trailer 5. In addition, the parking space 15 for parking the trailer 5 may be determined by the driver of the truck 6.

Here, the parking position of the trailer 5 is stored in the vehicle database 32 of the control device 3 together with, for example, information such as the type of the trailer 5, the dimensions of the trailer 5, whether or not to load the article, and the entry date and time. Here, when the control device 3 does not instruct the conveyance of the trailer 5, the conveyance vehicle 4 may stand by at a standby place which is a position that does not obstruct the movement of the truck 6 or another conveyance vehicle 4. When the conveyance of the trailer 5 is instructed, the conveyance vehicle 4 may stand by at the standby place after the conveyance. Note that the standby place is provided in the site of the delivery center 1 as a position that does not obstruct the movement of the truck 6 or the other conveyance vehicle 4. In the examples of FIGS. 8 to 13, a region 20 indicated by a broken line is the standby place. Furthermore, the position of the standby place may be stored in advance in the map information storing units 31 and 412. Here, if a passage for the truck 6 to travel is provided in the site of the delivery center 1, a region serving as a standby place may not be provided in the site of the delivery center 1, and a region outside the passage may be used as the standby place. In addition, the travel plan generating unit 33 may generate a travel plan that does not include a standby place in the travel route when the conveyance vehicle 4 executes conveyance of the trailer 5.

Parking of the trailer 5 by the truck 6 will be described with reference to FIG. 9. The truck 6 permitted to enter parks the trailer 5 in the designated parking space 15. In the example of FIG. 9, the designated parking space 15 is a parking space 15A.

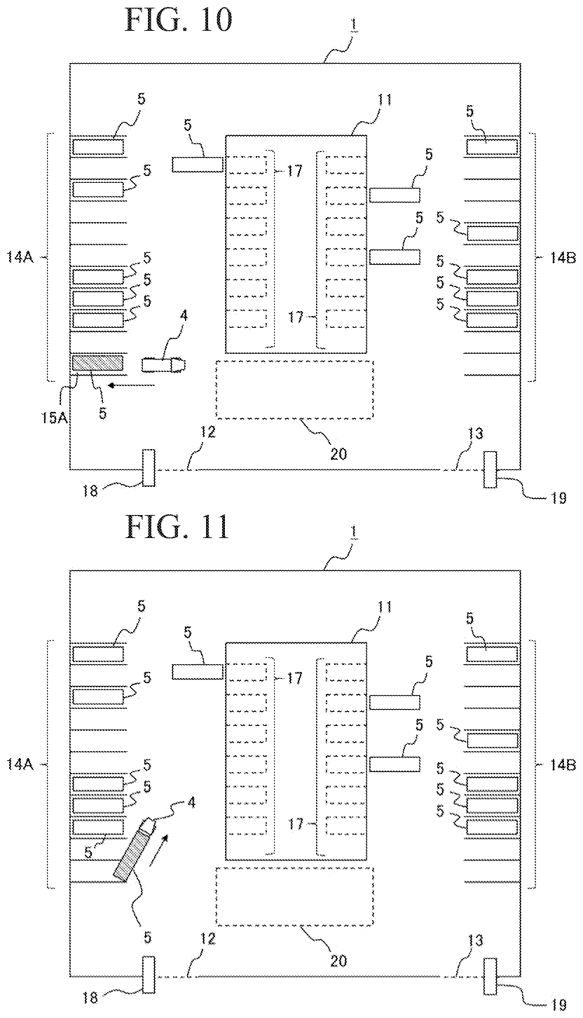

The connection between the conveyance vehicle 4 and the trailer 5 will be described with reference to FIG. 10. The conveyance vehicle 4 instructed to convey the trailer 5 by the control device 3 autonomously travels from a current position such as a standby position to a first parking position of the conveyance vehicle 4 that is included in the travel plan transmitted from the control device 3 and is a position where the trailer 5 is parked. Then, the conveyance vehicle 4 is connected to the trailer 5 by executing control by the driving control unit 411 and the connection control unit 424.

The conveyance of the trailer 5 to the platform 17 by the conveyance vehicle 4 will be described with reference to FIG. 11. The conveyance vehicle 4 connected to the trailer 5 moves the trailer 5 to the second parking position, which is a position for parking the trailer 5, included in the travel plan transmitted from the control device 3. When the trailer 5 is conveyed to the platform 17 by the conveyance vehicle 4, the second parking position is the platform 17 for loading or unloading the article.

Here, the platform 17 set as the second parking position may be one platform 17 among the platforms 17 on which no other conveyance vehicle 4 or trailer 5 is present specified by the peripheral recognition information generated by the recognition unit 35 of the control device 3, or may be one platform 17 among the plurality of platforms 17 designated by the administrator or the like of the delivery center 1. In the case of designation by the administrator or the like of the delivery center 1, the second parking position may be input to the control device 3 via the interface.

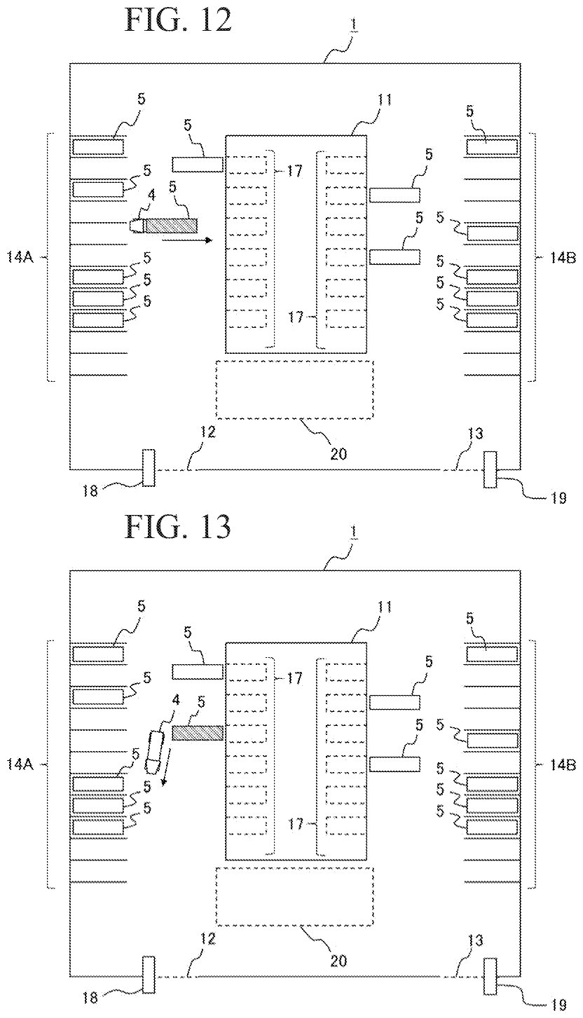

Parking of the trailer 5 to the platform 17 by the conveyance vehicle 4 will be described with reference to FIG. 12. The conveyance vehicle 4 connected to the trailer 5 conveys the trailer 5 to the platform 17 on which the article is loaded or unloaded, and changes the direction as necessary so as to arrange the open door provided on the trailer 5 on the platform 17 side. Thereafter, the conveyance vehicle 4 causes the trailer 5 to approach the platform 17 so that the article can be loaded or unloaded, and executes control by the connection control unit 424 to be disconnected from the trailer 5. Note that the parking position of the trailer 5 disconnected from the conveyance vehicle 4 may be stored in the vehicle database 32 of the control device 3 together with, for example, information such as the type of the trailer 5, the dimensions of the trailer 5, whether or not to load the article, and the parking date and time.

The operation of the conveyance vehicle 4 when the conveyance of the trailer 5 by the conveyance vehicle 4 is completed will be described with reference to FIG. 13. The conveyance vehicle 4 disconnected from the trailer 5 and having the trailer 5 parked at the platform 17, that is, the second parking position, is separated from the trailer 5 by autonomous traveling and stands by at a position that does not interfere with the movement of the truck 6 or the other conveyance vehicle 4, such as a standby place. In addition, the conveyance vehicle 4 disconnected from the trailer 5 may start the conveyance of another trailer 5 without standing by. As described above, the conveyance vehicle 4 conveys the trailer 5 from the parking space 15 to the platform 17.

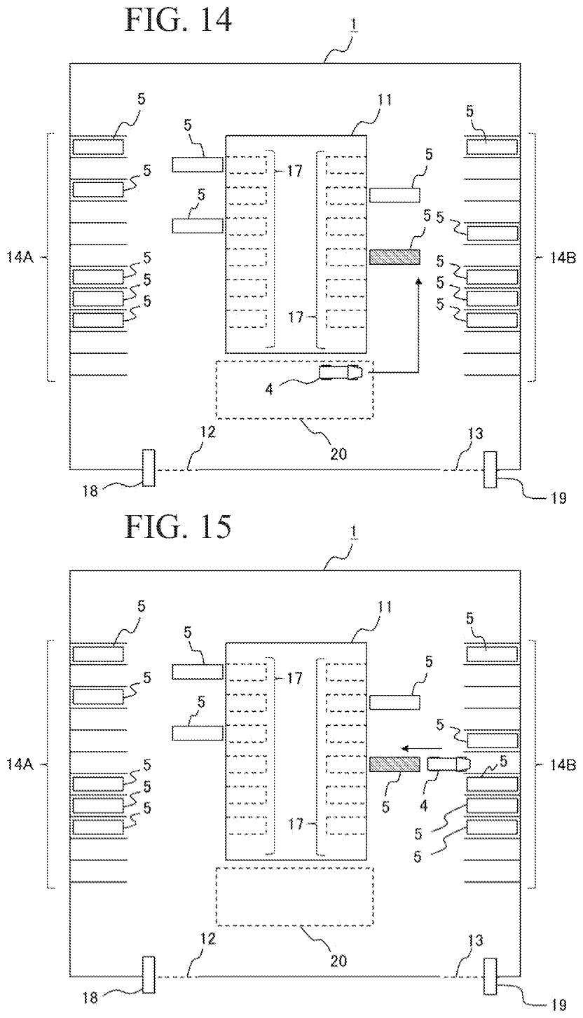

Next, the operation of the conveyance vehicle 4 related to the conveyance of the trailer 5 by the conveyance vehicle 4 from the warehouse 11 and the exit of the truck 6 towing the trailer 5 will be described. FIGS. 14 to 17 are explanatory diagrams illustrating the operation of the conveyance vehicle 4 according to the first embodiment. In FIGS. 14 to 17, the roadside sensor 2 is not illustrated for simplicity. Further, similarly to the examples of FIGS. 8 to 13, also in the examples of FIGS. 14 to 17, a region 20 indicated by a broken line is the standby place. In addition, the trailer 5 to be conveyed by the conveyance target 4 is hatched.

With reference to FIG. 14, autonomous traveling of the conveyance vehicle 4 to a position where the trailer 5 is parked will be described. The conveyance vehicle 4 instructed by the control device 3 to convey the trailer 5 autonomously travels from a current position such as a standby position to a first parking position of the conveyance vehicle 4 that is included in the travel plan transmitted from the control device 3 and is a position where the trailer 5 is parked. Note that in the example of FIG. 14, the first parking position is the platform 17 of the warehouse 11.

The connection between the conveyance vehicle 4 and the trailer 5 will be described with reference to FIG. 15. The conveyance vehicle 4 having moved to the first parking position is connected to the trailer 5 by executing control by the driving control unit 411 and the connection control unit 424.

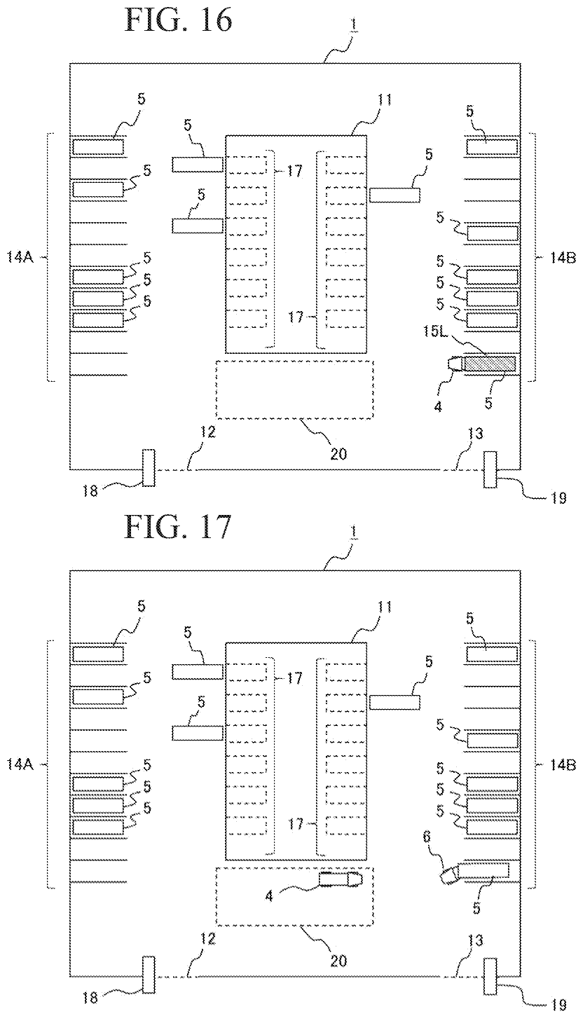

The conveyance of the trailer 5 to the parking space 15 by the conveyance vehicle 4 will be described with reference to FIG. 16. The conveyance vehicle 4 connected to the trailer 5 moves the trailer 5 to the second parking position, which is a position for parking the trailer 5, included in the travel plan transmitted from the control device 3. When the trailer 5 is conveyed to the parking space 15 by the conveyance vehicle 4, the second parking position is a parkable section.

Thereafter, the conveyance vehicle 4 changes the direction as necessary so that the trailer 5 can be towed by the truck 6, and is disconnected from the trailer 5 in the parking space 15 to park the trailer 5. Here, the parking position of the trailer 5 may be stored in the vehicle database 32 of the control device 3 together with, for example, information such as the type of the trailer 5, the dimensions of the trailer 5, whether or not to load the article, and the parking date and time. Note that in the example of FIG. 16, the parking position of the trailer 5 is the parking space 15L. As described above, the conveyance vehicle 4 conveys the trailer 5 from the platform 17 to the parking space 15.

Towing of the trailer 5 by the truck 6 will be described with reference to FIG. 17. The truck 6 permitted to enter tows the trailer 5 designated by the surveillance staff or the like of the entrance gate 18, and carries the trailer 5 out of the delivery center 1 via the exit gate 19 of the delivery center 1. Here, the conveyance vehicle 4 that has completed the conveyance of the trailer 5 may be caused to stand by at a standby place or the like that does not obstruct the movement of the truck 6 or another conveyance vehicle 4.

Incidentally, in the delivery center 1, there is traffic of a truck 6 which is one of the extraneous vehicles. In such a delivery center 1, the driver of the truck 6 may decide whether to prioritize traveling of the conveyance vehicle 4 or traveling of the truck 6. Therefore, in the delivery center 1 in which the conveyance vehicle 4 and the truck 6 are mixed, there is a possibility that the operation efficiency of the delivery center 1 is reduced due to, for example, interference between the travel route of the conveyance vehicle 4 and the travel route of the truck 6.

Therefore, the travel plan generating unit 33 included in the control device 3 of the present disclosure includes the extraneous vehicle determining unit 334 that determines whether or not an extraneous vehicle is present in the site, and when the extraneous vehicle determining unit 334 determines that an extraneous vehicle is present in the site, the travel plan generating unit 33 generates a travel plan that does not obstruct traveling of the extraneous vehicle by the conveyance vehicle 4.

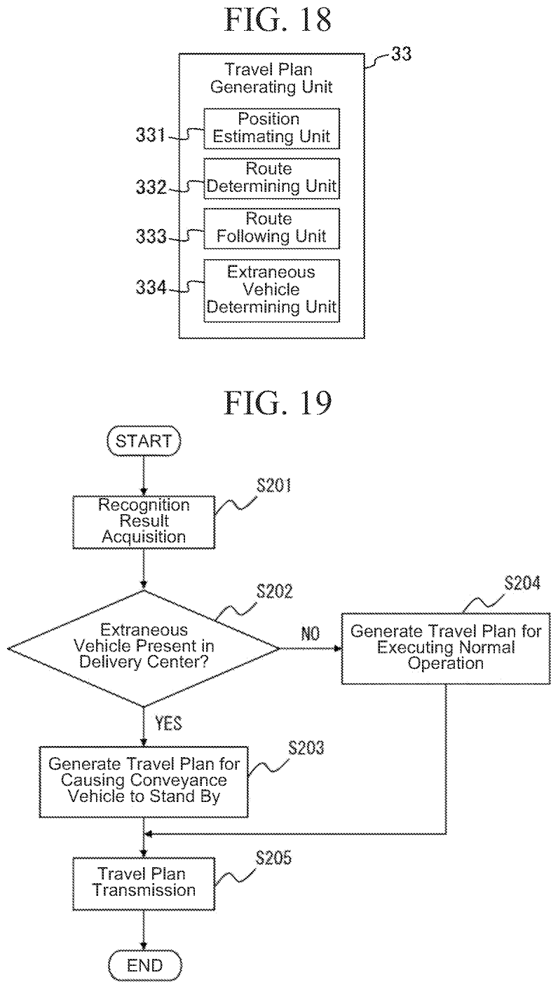

FIG. 18 is an explanatory diagram illustrating a part of the configuration of the control device 3 according to the first embodiment. The extraneous vehicle determining unit 334 included in the travel plan generating unit 33 determines whether or not an extraneous vehicle is present in the site of the delivery center 1 by using a recognition result acquired from at least one of the recognition unit 35 and the peripheral recognition unit 416. Specifically, if it is specified from the recognition result that an extraneous vehicle such as the truck 6 is present in the site of the delivery center 1, the extraneous vehicle determining unit 334 determines that an extraneous vehicle is present in the site of the delivery center 1, and if it is not specified that an extraneous vehicle such as the truck 6 is present in the site of the delivery center 1, the extraneous vehicle determining unit 334 determines that an extraneous vehicle is not present in the site of the delivery center 1.

In addition, in a case where it is confirmed that the truck 6 has entered the delivery center 1 by the surveillance staff or the like at the entrance gate 18, and information indicating that the truck 6 is present in the delivery center 1 is stored in the vehicle database 32 of the control device 3 by an operation of a terminal or the like operable by the surveillance staff, the extraneous vehicle determining unit 334 may determine that an extraneous vehicle is present in the site of the delivery center 1. In this case, when it is confirmed by the surveillance staff or the like at the exit gate 19 that the truck 6 has exited from the delivery center 1, and information indicating that the truck 6 has exited from the delivery center 1 is stored in the vehicle database 32 by an operation of a terminal or the like operable by the surveillance staff, or when information on the truck 6 is deleted from the vehicle database 32, the extraneous vehicle determining unit 334 may determine that no extraneous vehicle is present in the site of the delivery center 1.

Here, if at least one extraneous vehicle is present in the site of the delivery center 1, the extraneous vehicle determining unit 334 may determine that an extraneous vehicle is present. In this case, if no extraneous vehicle is present in the site of the delivery center 1, the extraneous vehicle determining unit 334, the extraneous vehicle determining unit 334 may determine that no extraneous vehicle is present in the site of the delivery center 1. In addition, if a predetermined number or more of extraneous vehicles are present, the extraneous vehicle determining unit 334 may determine that extraneous vehicles are present in the site. In this case, if the number of extraneous vehicles present in the site of the delivery center 1 is less than the predetermined number, the extraneous vehicle determining unit 334 may determine that no extraneous vehicle is present in the site.

In addition, the extraneous vehicle determining unit 334 may determine whether or not an extraneous vehicle is present on the basis of whether or not an extraneous vehicle is present within a predetermined range from the conveyance vehicle 4. In a case where the travel plan generating unit 33 generates a travel plan that does not obstruct the traveling of the extraneous vehicle by the conveyance vehicle 4, it is possible to generate a travel plan according to the peripheral situation of each conveyance vehicle 4 with respect to the plurality of conveyance vehicles 4 by determining whether or not the extraneous vehicle is present in the site on the basis of whether or not the extraneous vehicle is present within a predetermined range from the conveyance vehicle 4. In this case, the travel plan generating unit 33 may generate and transmit a travel plan that does not obstruct the traveling of the extraneous vehicle by the conveyance vehicle 4 to the conveyance vehicle 4 from which the extraneous vehicle is present within a predetermined range, and the travel plan generating unit 33 may generate and transmit a travel plan for executing a normal operation to be described later to the conveyance vehicle 4 from which the extraneous vehicle is not present within the predetermined range.

Furthermore, in a case where it is possible to specify a day or a period during which the extraneous vehicles frequently come and go, the extraneous vehicle determining unit 334 may determine that the extraneous vehicle is present on the day or the period during which the extraneous vehicles frequently come and go. Similarly, in a case where it is possible to specify a day or a period during which the extraneous vehicles do not frequently come and go, the extraneous vehicle determining unit 334 may determine that the extraneous vehicle is not present on the day or the period during which the extraneous vehicles do not frequently come and go.

In addition, in a case where both the determination based on the extraneous vehicle present in the site and the determination based on the date or the period on which the extraneous vehicles frequently come and go and the date or the period on which the extraneous vehicles do not frequently come and go are performed by the extraneous vehicle determining unit 334, it is preferable to give priority to the determination result based on the extraneous vehicle present in the site. In this way, even if there is a change in the date or the period on which the extraneous vehicles frequently come and go and the date or the period on which the extraneous vehicles do not frequently come and go, it is possible to perform the determination according to the actual situation of the delivery center 1.

Note that the date or the period on which the extraneous vehicles frequently come and go and the date or period on which the extraneous vehicles do not frequently come and go can be specified with reference to the entry date and time, the exit date and time, and the like of the extraneous vehicle stored in the vehicle database 32.

Next, generation of a travel plan by the travel plan generating unit 33 when the extraneous vehicle determining unit 334 determines that an extraneous vehicle is present in the site will be described. When the extraneous vehicle determining unit 334 determines that an extraneous vehicle is present in the site, the travel plan generating unit 33 according to the present embodiment generates a travel plan for causing the conveyance vehicle 4 to stand by outside a passage on which the extraneous vehicle provided in the site travels or the like.

Specifically, when the extraneous vehicle determining unit 334 determines that an extraneous vehicle is present in the site, the travel plan generating unit 33 generates a travel plan for causing the conveyance vehicle 4 to stand by at a standby place provided in the site. That is, the travel plan generating unit 33 generates a travel plan in which the current position of the conveyance vehicle 4 is set as the start point of the travel route and the standby place is set as the end point of the travel route.

Then, when the extraneous vehicle determining unit 334 determines that no extraneous vehicle is present in the site, the travel plan generating unit 33 generates a travel plan for executing normal operation, and restarts the conveyance of the trailer 5 by the conveyance vehicle 4.

Here, the movement of the conveyance vehicle 4 to the standby place can be executed regardless of whether or not the trailer 5 is being conveyed. On the other hand, when the conveyance vehicle 4 that is conveying the trailer 5 is moved to the standby place, there is a possibility that the movement of other conveyance vehicles 4 is hindered and the operation efficiency of the delivery center 1 is lowered. Therefore, it is preferable that the travel plan that does not obstruct the traveling of the extraneous vehicle generated by the travel plan generating unit 33 is transmitted to the conveyance vehicle 4 engaged in the conveyance work of the trailer 5 after the conveyance work is completed. In addition, a travel plan that is generated by the travel plan generating unit 33 and does not obstruct the traveling of the extraneous vehicle may be transmitted to the conveyance vehicle 4 engaged in the conveyance work of the trailer 5, and after the conveyance vehicle 4 finishes the conveyance work, traveling based on the travel plan may be executed.

On the other hand, when the extraneous vehicle determining unit 334 determines that the extraneous vehicle is not present in the site, the travel plan generating unit 33 generates a travel plan necessary for normal operation of the conveyance vehicle 4. Here, the normal operation refers to, for example, conveyance of the trailer 5 parked in the parking space 15 to the platform 17 or conveyance of the trailer 5 parked in the platform 17 to the parking space 15 based on an instruction from the control device 3 without waiting, correction of the travel plan, or the like due to the presence of an extraneous vehicle by the conveyance vehicle 4. In addition, the normal operation may refer to execution of at least the movement of the trailer 5 by the conveyance vehicle 4 based on the instruction from the control device 3, without waiting, correction of the travel plan, or the like due to the presence of an extraneous vehicle.

Next, an operation of the conveyance system 100 in the present embodiment will be described. FIG. 19 is a flowchart illustrating an operation example of the conveyance system 100 according to the first embodiment. Note that, regarding the operation example of FIG. 19, for example, the operation of the conveyance system 100 may be started at the start of operation of the delivery center 1, and the operation of the conveyance system 100 may be ended at the end of operation of the delivery center 1.

In step S201, the extraneous vehicle determining unit 334 of the conveyance system 100 acquires a recognition result from at least one of the recognition unit 35 and the peripheral recognition unit 416. Here, the recognition result is an object detection result derived by at least one of the recognition unit 35 and the peripheral recognition unit 416 using the sensor information.

In step S202, the extraneous vehicle determining unit 334 of the conveyance system 100 determines whether or not an extraneous vehicle is present in the site of the delivery center 1 by using the recognition result acquired from at least one of the recognition unit 35 and the peripheral recognition unit 416.

Next, when the travel plan generating unit 33 of the conveyance system 100 acquires the determination result indicating that an extraneous vehicle is present in the site of the delivery center 1 from the extraneous vehicle determining unit 334 (S202: YES), the travel plan generating unit generates a travel plan for causing the conveyance vehicle 4 to stand by at the standby place in step S203. Then, in step S205, the travel plan generating unit 33 transmits the generated travel plan to the conveyance vehicle 4. Note that, after the travel plan is generated in the conveyance vehicle 4, the process proceeds to step S201, and the determination by the extraneous vehicle determining unit 334 may be executed again.

On the other hand, when the travel plan generating unit 33 of the conveyance system 100 has acquired the determination result indicating that no extraneous vehicle is present in the site of the delivery center 1 from the extraneous vehicle determining unit 334 (S202: NO), the travel plan generating unit generates a travel plan for causing the conveyance vehicle 4 to execute normal operation in step S204. Then, in step S205, the travel plan generating unit 33 transmits the generated travel plan to the conveyance vehicle 4. Note that, after the travel plan is generated in the conveyance vehicle 4, the process proceeds to step S201, and the determination by the extraneous vehicle determining unit 334 may be executed again.

As described above, in a case where an extraneous vehicle such as the truck 6 is present in the site of the delivery center 1, if the conveyance vehicle 4 is caused to stand by at the standby place, predictability of the travel route of the conveyance vehicle 4 by the driver of the extraneous vehicle is improved. In addition, by causing the conveyance vehicle 4 to stand by at the standby place, it is possible to suppress the presence of the conveyance vehicle 4 on the travel route of the extraneous vehicle. Therefore, it is possible to prevent the travel route of the conveyance vehicle 4 and the travel route of the extraneous vehicle from interfering with each other, and the operation efficiency of the delivery center 1 is improved.

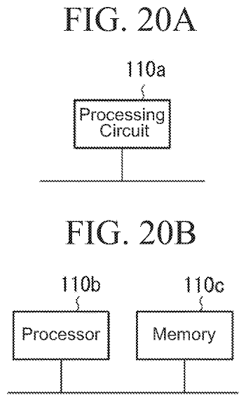

Next, a hardware configuration that implements the functions of the conveyance system 100 will be described. FIG. 20A and FIG. 20B are diagrams illustrating a hardware configuration example of the conveyance system 100 according to the first embodiment. The control device 3, the map information storing unit 31, the vehicle database 32, the travel plan generating unit 33, the communication unit 34, the recognition unit 35, the position estimating unit 331, the route determining unit 332, the route following unit 333, the extraneous vehicle determining unit 334, the driving control device 41, the driving control unit 411, the map information storing unit 412, the peripheral situation monitoring unit 413, the peripheral recognition unit 416, the vehicle state acquiring unit 417, the in-vehicle communication unit 423, and the connection control unit 424 in the conveyance system 100 may be a processing circuit 110a that is dedicated hardware as illustrated in FIG. 20A, or may be a processor 110b that executes a program stored in a memory 110c as illustrated in FIG. 20B.

As illustrated in FIG. 20A, in a case where the control device 3, the map information storing unit 31, the vehicle database 32, the travel plan generating unit 33, the communication unit 34, the recognition unit 35, the position estimating unit 331, the route determining unit 332, the route following unit 333, the extraneous vehicle determining unit 334, the driving control device 41, the driving control unit 411, the map information storing unit 412, the peripheral situation monitoring unit 413, the peripheral recognition unit 416, the vehicle state acquiring unit 417, the in-vehicle communication unit 423, and the connection control unit 424 are dedicated hardware, the processing circuit 110a corresponds to, for example, a single circuit, a composite circuit, a programmed processor, a parallel-programmed processor, an application specific integrated circuit (ASIC), a field-programmable gate array (FPGA), or a combination thereof. Each of the functions of the control device 3, the map information storing unit 31, the vehicle database 32, the travel plan generating unit 33, the communication unit 34, the recognition unit 35, the position estimating unit 331, the route determining unit 332, the route following unit 333, the extraneous vehicle determining unit 334, the driving control device 41, the driving control unit 411, the map information storing unit 412, the peripheral situation monitoring unit 413, the peripheral recognition unit 416, the vehicle state acquiring unit 417, the in-vehicle communication unit 423, and the connection control unit 424 may be implemented by a processing circuit, or the functions of the respective units may be collectively implemented by one processing circuit.

As illustrated in FIG. 20B, when the control device 3, the map information storing unit 31, the vehicle database 32, the travel plan generating unit 33, the communication unit 34, the recognition unit 35, the position estimating unit 331, the route determining unit 332, the route following unit 333, the extraneous vehicle determining unit 334, the driving control device 41, the driving control unit 411, the map information storing unit 412, the peripheral situation monitoring unit 413, the peripheral recognition unit 416, the vehicle state acquiring unit 417, the in-vehicle communication unit 423, and the connection control unit 424 are the processor 110b, the functions of the respective units are implemented by software, firmware, or a combination of software and firmware. Software or firmware is described as a program and stored in the memory 110c. The processor 110b reads and executes the program stored in the memory 110c, thereby implementing the functions of the control device 3, the map information storing units 31 and 412, the vehicle database 32, the travel plan generating unit 33, the communication unit 34, the recognition unit 35, the driving control device 41, the position estimating unit 331, the route determining unit 332, the route following unit 333, the extraneous vehicle determining unit 334, the driving control unit 411, the map information storing unit 412, the peripheral situation monitoring unit 413, the peripheral recognition unit 416, the vehicle state acquiring unit 417, the in-vehicle communication unit 423, and the connection control unit 424. That is, the control device 3, the map information storing unit 31, the vehicle database 32, the travel plan generating unit 33, the communication unit 34, the recognition unit 35, the position estimating unit 331, the route determining unit 332, the route following unit 333, the extraneous vehicle determining unit 334, the driving control device 41, the driving control unit 411, the map information storing unit 412, the peripheral situation monitoring unit 413, the peripheral recognition unit 416, the vehicle state acquiring unit 417, the in-vehicle communication unit 423, and the connection control unit 424 include the memory 110c for storing programs that result in execution of each step illustrated in FIG. 7 and the like when executed by the processor 110b. It can also be said that these programs cause a computer to execute the procedures or methods performed by the control device 3, the map information storing units 31 and 412, the vehicle database 32, the travel plan generating unit 33, the communication unit 34, the recognition unit 35, the driving control device 41, the position estimating unit 331, the route determining unit 332, the route following unit 333, the extraneous vehicle determining unit 334, the driving control unit 411, the map information storing unit 412, the peripheral situation monitoring unit 413, the peripheral recognition unit 416, the vehicle state acquiring unit 417, the in-vehicle communication unit 423, and the connection control unit 424.

Here, the processor 110b is, for example, a central processing unit (CPU), a processing device, an arithmetic device, a processor, a microprocessor, a microcomputer, a digital signal processor (DSP), or the like. The memory 110c may be, for example, a nonvolatile or volatile semiconductor memory such as a random access memory (RAM), a read only memory (ROM), a flash memory, an erasable programmable ROM (EPROM), or an electrically EPROM (EEPROM), a magnetic disk such as a hard disk or a flexible disk, or an optical disk such as a mini disk, a compact disc (CD), or a digital versatile disc (DVD).

Note that some of the functions of the control device 3, the map information storing unit 31, the vehicle database 32, the travel plan generating unit 33, the communication unit 34, the recognition unit 35, the position estimating unit 331, the route determining unit 332, the route following unit 333, the extraneous vehicle determining unit 334, the driving control device 41, the driving control unit 411, the map information storing unit 412, the peripheral situation monitoring unit 413, the peripheral recognition unit 416, the vehicle state acquiring unit 417, the in-vehicle communication unit 423, and the connection control unit 424 may be implemented by dedicated hardware, and some may be implemented by software or firmware. As described above, the processing circuit 110a in the conveyance system 100 can implement the above-described functions by hardware, software, firmware, or a combination thereof. In addition, at least some of the functions of the control device 3, the map information storing unit 31, the vehicle database 32, the travel plan generating unit 33, the communication unit 34, the recognition unit 35, the position estimating unit 331, the route determining unit 332, the route following unit 333, the extraneous vehicle determining unit 334, the driving control device 41, the driving control unit 411, the map information storing unit 412, the peripheral situation monitoring unit 413, the peripheral recognition unit 416, the vehicle state acquiring unit 417, the in-vehicle communication unit 423, and the connection control unit 424 may be executed by a server present outside the conveyance system 100.

As described above, when the travel plan generating unit 33 that generates a travel plan of the conveyance vehicle 4 used for execution of conveyance of the trailer 5 from the parking lot 14 to the warehouse 11 or conveyance of the trailer 5 from the warehouse 11 to the parking lot 14 by the conveyance vehicle 4, and the extraneous vehicle determining unit 334 that determines whether or not an extraneous vehicle is present in the site are included, and when the extraneous vehicle determining unit 334 determines that an extraneous vehicle is present in the site, the travel plan generating unit 33 generates a travel plan that does not obstruct the traveling of the extraneous vehicle by the conveyance vehicle 4, the conveyance vehicle 4 does not obstruct the traveling of the extraneous vehicle such as the truck 6, so that the operation efficiency of the delivery center 1 can be improved.

### Second Embodiment

A conveyance system 100 according to a second embodiment includes a travel plan generating unit 33 as in the first embodiment. The present embodiment is different from the first embodiment in that the travel plan generating unit 33 estimates an orbital path (hereinafter referred to as “track”) on which an extraneous vehicle travels and generates a travel plan of a conveyance vehicle 4 using a result of the estimation. The same components as those in the first embodiment are denoted by the same reference numerals, and the description thereof will be omitted.

The travel plan generating unit 33 according to the present embodiment estimates the track on which the extraneous vehicle travels using the position where the extraneous vehicle parks the trailer 5 or the parking position of the trailer 5 to be towed by the extraneous vehicle. Specifically, the travel plan generating unit 33 estimates the track on which the extraneous vehicle travels using the position information of the extraneous vehicle such as the truck 6 acquired by the roadside sensor 2 or the in-vehicle sensor, the position where the extraneous vehicle parks the trailer 5 or the position information of the trailer 5 to be towed by the extraneous vehicle, and the position information of the entrance gate 18 or the exit gate 19.

Note that, for example, if the parking position of the trailer 5 instructed by the surveillance staff or the like of the entrance gate 18, the parking position of the trailer 5 parked in the parking lot 14 by the conveyance vehicle 4, and the like are stored in the vehicle database 32 or the like of the control device 3 using the parking position of the trailer 5 output from the terminal operated by the surveillance staff or the parking position of the trailer 5 included in the travel plan, the parking position information is stored in the vehicle database 32 in association with the trailer 5. Therefore, the travel plan generating unit 33 may use the position information of the trailer 5 stored in the vehicle database 32 as the position where the extraneous vehicle parks the trailer 5 or the position information of the trailer 5 to be towed by the extraneous vehicle.

Then, when the extraneous vehicle determining unit 334 determines that an extraneous vehicle is present in the site, the travel plan generating unit 33 generates a travel plan for avoiding entry of the conveyance vehicle 4 into the track on which the extraneous vehicle is estimated to travel.

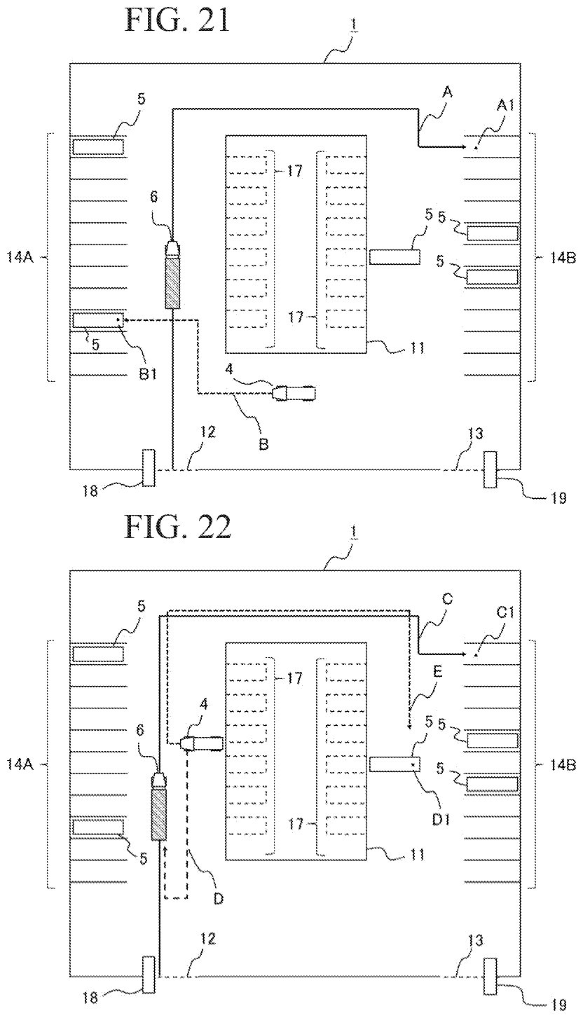

A travel plan for avoiding entry of the conveyance vehicle 4 into the track on which the extraneous vehicle travels will be specifically described. FIG. 21 is an explanatory diagram illustrating a travel plan generated by the travel plan generating unit 33 according to the second embodiment. A solid line A in FIG. 21 indicates a track on which the truck 6, which is one of the extraneous vehicles, travels, and a broken line B indicates a travel route included in a travel plan for avoiding entry of the conveyance vehicle 4 into the track on which the extraneous vehicle travels. A point A1 is an end point of a track A, and a point B1 is an end point of a track B.

As illustrated in FIG. 21, the track B is a travel route generated so that the conveyance vehicle 4 does not cross a track on which the truck 6 travels in the future with respect to the track A which is a track on which the truck 6 travels. In a case where the route connecting the current position of the conveyance vehicle 4 and a target point of autonomous traveling crosses the track on which the extraneous vehicle travels in the generated travel plan, the travel plan generating unit 33 changes or updates the travel plan so as not to cross the track of the extraneous vehicle.

In this case, the changed or updated travel plan may be, for example, one in which the route determining unit 332 changes or updates the travel route so as not to cross the track of the extraneous vehicle, or one in which the route following unit 333 changes or updates the control information so as to stand by until the extraneous vehicle crosses the travel route of the conveyance vehicle 4. That is, the fact that the conveyance vehicle 4 does not cross the track of the extraneous vehicle means that the conveyance vehicle 4 does not cross in front of the extraneous vehicle. Note that the travel plan generating unit 33 may generate a travel plan in which the conveyance vehicle 4 does not cross the track of the extraneous vehicle when it is estimated that the conveyance vehicle 4 crosses the track on which the extraneous vehicle travels from the current position of the conveyance vehicle 4 and the target position of autonomous traveling. That is, generation of the travel plan in which the conveyance vehicle 4 does not cross the track of the extraneous vehicle does not necessarily require change or update of the already generated travel plan.

In addition, when the extraneous vehicle determining unit 334 determines that the extraneous vehicle is present in the site, the travel plan generating unit 33 may generate a travel plan for causing the conveyance vehicle 4 to follow the extraneous vehicle or a travel plan for causing the conveyance vehicle 4 to precede the extraneous vehicle.

A travel plan for causing the conveyance vehicle 4 to follow the extraneous vehicle and a travel plan for causing the conveyance vehicle 4 to precede the extraneous vehicle will be specifically described. FIG. 22 is an explanatory diagram illustrating a travel plan generated by the travel plan generating unit 33 according to the second embodiment. A solid line C in FIG. 22 indicates a track on which the truck 6, which is one of the extraneous vehicles, travels. A broken line D indicates a travel route included in the travel plan for causing the conveyance vehicle 4 to follow the extraneous vehicle. A broken line E indicates a travel route included in a travel plan for causing the conveyance vehicle 4 to precede the extraneous vehicle. Note that a point C1 is the end point of a track C, a point D1 is the end point of a track D, and a point E1 is the end point of a track E.

As illustrated in FIG. 22, with respect to the track C which is a track on which the truck 6 travels, the track D is a travel route generated so that the conveyance vehicle 4 follows the extraneous vehicle on a track on which the truck 6 has traveled in the past. In a case where the route connecting the current position of the conveyance vehicle 4 and the target point of the autonomous traveling partially or entirely overlaps with the track on which the extraneous vehicle travels in the generated travel plan, the travel plan generating unit 33 changes or updates the travel plan so that the conveyance vehicle 4 follows the extraneous vehicle on the track on which the extraneous vehicle has traveled in the past.

In this case, the changed or updated travel plan may be, for example, one in which the travel route is changed or updated by the route determining unit 332 so as to follow the route on which the extraneous vehicle has traveled in the past, or one in which the control information is changed or updated by the route following unit 333 so as to prevent the conveyance vehicle 4 from approaching the preceding extraneous vehicle to a certain degree of risk of collision. Note that, when it is estimated that the route connecting the current position of the conveyance vehicle 4 and the target position of autonomous traveling partially or entirely overlaps with the track on which the extraneous vehicle travels, the travel plan generating unit 33 may generate a travel plan for causing the conveyance vehicle 4 to follow the extraneous vehicle. That is, generation of the travel plan for causing the conveyance vehicle 4 to follow the extraneous vehicle does not necessarily require change or update of the already generated travel plan.

In addition, as illustrated in FIG. 22, with respect to the track C which is a track on which the truck 6 travels, the track E is a travel route generated so that the conveyance vehicle 4 precedes the extraneous vehicle on a track on which the truck 6 will travel in the future. In a case where the route connecting the current position of the conveyance vehicle 4 and the target point of autonomous traveling partially or entirely overlaps with the track on which the extraneous vehicle travels in the generated travel plan, the travel plan generating unit 33 changes or updates the travel plan so that the conveyance vehicle 4 precedes the extraneous vehicle on the track on which the extraneous vehicle will travel in the future.

In this case, the changed or updated travel plan may be, for example, one in which the travel route is changed or updated by the route determining unit 332 so as to precede in the track on which the extraneous vehicle will travel in the future, or one in which the control information is changed or updated by the route following unit 333 so as to prevent the conveyance vehicle 4 from approaching the extraneous vehicle to some extent with the risk of collision. Note that the travel plan generating unit 33 may generate a travel plan for causing the conveyance vehicle 4 to follow the extraneous vehicle in a case where it is estimated that the route connecting the current position of the conveyance vehicle 4 and the target position of the autonomous traveling partially or entirely overlaps with the track on which the extraneous vehicle travels. That is, generation of the travel plan for causing the conveyance vehicle 4 to follow the extraneous vehicle does not necessarily require change or update of the already generated travel plan.

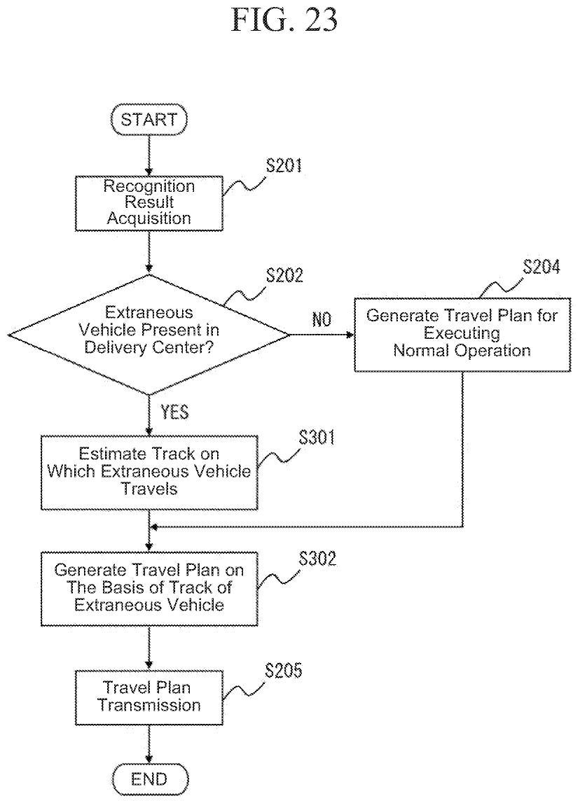

Next, an operation of the conveyance system 100 in the present embodiment will be described. FIG. 23 is a flowchart illustrating an operation example of the conveyance system 100 according to the second embodiment. Note that, regarding the operation example of FIG. 23, for example, the operation of the conveyance system 100 may be started at the start of operation of the delivery center 1, and the operation of the conveyance system 100 may be ended at the end of operation of the delivery center 1. Description of the processing described in the embodiment will be omitted as appropriate.

In step S201, the extraneous vehicle determining unit 334 of the conveyance system 100 acquires a recognition result from at least one of the recognition unit 35 and the peripheral recognition unit 416.

In step S202, the extraneous vehicle determining unit 334 of the conveyance system 100 determines whether or not an extraneous vehicle is present in the site of the delivery center 1 by using the recognition result acquired from at least one of the recognition unit 35 and the peripheral recognition unit 416.

Next, when the travel plan generating unit 33 of the conveyance system 100 acquires the determination result indicating that the extraneous vehicle is present in the site of the delivery center 1 from the extraneous vehicle determining unit 334 (S202: YES), the travel plan generating unit estimates the track on which the extraneous vehicle travels in step S301.

Then, in S302, the travel plan generating unit 33 generates a travel plan of the conveyance vehicle 4 on the basis of the track on which the extraneous vehicle is estimated to travel. Here, between the processing of S301 and S302, the travel plan generating unit 33 may estimate whether the route connecting the current position of the conveyance vehicle 4 and the target position of autonomous traveling partially or entirely overlaps with a track on which the extraneous vehicle travels or crosses the track on which the extraneous vehicle travels.

In this case, when the conveyance vehicle 4 is estimated to cross the track on which the extraneous vehicle travels from the current position of the conveyance vehicle 4 and the target position of the autonomous traveling, the travel plan generating unit 33 may generate, in the processing of S302, a travel plan in which the conveyance vehicle 4 does not cross the track of the extraneous vehicle. Further, when it is estimated that the route connecting the current position of the conveyance vehicle 4 and the target position of the autonomous traveling partially or entirely overlaps with the track on which the extraneous vehicle travels, the travel plan generating unit 33 may generate, in the processing of S302, a travel plan for causing the conveyance vehicle 4 to follow the extraneous vehicle or a travel plan for causing the conveyance vehicle 4 to precede the extraneous vehicle.

Then, in step S205, the travel plan generating unit 33 transmits the generated travel plan to the conveyance vehicle 4. Note that, after the travel plan is generated in the conveyance vehicle 4, the process proceeds to step S201, and the determination by the extraneous vehicle determining unit 334 may be executed again.

On the other hand, when the travel plan generating unit 33 of the conveyance system 100 has acquired the determination result indicating that no extraneous vehicle is present in the site of the delivery center 1 from the extraneous vehicle determining unit 334 (S202: NO), the travel plan generating unit generates a travel plan for causing the conveyance vehicle 4 to execute normal operation in step S204. Then, in step S205, the travel plan generating unit 33 transmits the generated travel plan to the conveyance vehicle 4. Note that, after the travel plan is generated in the conveyance vehicle 4, the process proceeds to step S201, and the determination by the extraneous vehicle determining unit 334 may be executed again.

As described above, in a case where an extraneous vehicle such as the truck 6 is present in the site of the delivery center 1, if the conveyance vehicle 4 is caused to stand by at the standby place, predictability of the travel route of the conveyance vehicle 4 by the driver of the extraneous vehicle is improved. In addition, by causing the conveyance vehicle 4 to stand by at the standby place, it is possible to suppress the presence of the conveyance vehicle 4 on the travel route of the extraneous vehicle. Therefore, it is possible to prevent the travel route of the conveyance vehicle 4 and the travel route of the extraneous vehicle from interfering with each other, and the operation efficiency of the delivery center 1 is improved.

As described above, when the travel plan generating unit 33 of the conveyance system 100 generates a travel plan using the estimated track on which the extraneous vehicle travels, the traveling of the extraneous vehicle such as the truck 6 is not obstructed by the conveyance vehicle 4, so that the operation efficiency of the delivery center 1 can be improved.

Note that, in the first to second embodiments, an example has been described in which the extraneous vehicle determining unit 334 performs determination on an extraneous vehicle that enters the delivery center 1 from the outside of the delivery center 1, such as the truck 6, or an extraneous vehicle that exits from the delivery center 1 to the outside of the delivery center 1, but the extraneous vehicle determining unit 334 may perform determination on a vehicle that is managed in the delivery center 1 and cannot autonomously travel, for example, in addition to the above-described extraneous vehicle.

Note that, in the first to second embodiments, a part of the configuration of the control device 3 may be provided in the driving control device 41 of the conveyance vehicle 4 or the edge server. In addition, a part of the configuration of the driving control device 41 of the conveyance vehicle 4 may be provided in the control device 3 or the edge server. Furthermore, the control device 3 and the edge server may be provided in the delivery center 1 or may be provided in a facility outside the delivery center 1.

In addition, each embodiment disclosed in the present specification can be freely combined within the scope thereof, and each embodiment can be appropriately modified or omitted.

Hereinafter, various aspects of the present disclosure will be collectively described as supplements.

(Supplement 1)

A conveyance system for connecting a conveyance vehicle to a trailer parked in a site of a delivery center and moving the trailer to a warehouse provided in the delivery center or a parking lot of the delivery center, the conveyance system including:
a travel plan generating unit to generate a travel plan of the conveyance vehicle, the travel plan being used to execute conveyance of the trailer from the parking lot to the warehouse by the conveyance vehicle or conveyance of the trailer from the warehouse to the parking lot; and
an extraneous vehicle determining unit to determine whether or not an extraneous vehicle is present in the site, in which
the travel plan generating unit generates the travel plan in which the conveyance vehicle does not obstruct traveling of the extraneous vehicle when the extraneous vehicle determining unit determines that the extraneous vehicle is present in the site.

(Supplement 2)

The conveyance system according to Supplement 1, in which the travel plan generating unit generates the travel plan for causing the conveyance vehicle to stand by at a standby place provided in the site when the extraneous vehicle determining unit determines that the extraneous vehicle is present in the site.

(Supplement 3)

The conveyance system according to Supplement 1 or 2, in which the travel plan generating unit generates the travel plan for causing the conveyance vehicle to stand by outside a passage on which the extraneous vehicle travels provided in the site when the extraneous vehicle determining unit determines that the extraneous vehicle is present in the site.

(Supplement 4)

The conveyance system according to any one of Supplements 1 to 3, in which the travel plan generating unit estimates a track on which the extraneous vehicle travels using a position where the extraneous vehicle parks the trailer or a parking position of the trailer to be towed by the extraneous vehicle.

(Supplement 5)

The conveyance system according to claim 4, in which the travel plan generating unit generates the travel plan for avoiding entry of the conveyance vehicle into the estimated track on which the extraneous vehicle travels when the extraneous vehicle determining unit determines that the extraneous vehicle is present in the site.

(Supplement 5)

The conveyance system according to any one of Supplements 1 to 4, in which the travel plan generating unit generates the travel plan for avoiding entry of the conveyance vehicle into the estimated track on which the extraneous vehicle travels when the extraneous vehicle determining unit determines that the extraneous vehicle is present in the site.

(Supplement 6)

The conveyance system according to any one of Supplements 1 to 5, in which the travel plan generating unit generates the travel plan in which the conveyance vehicle does not cross the estimated track on which the extraneous vehicle travels when the extraneous vehicle determining unit determines that the extraneous vehicle is present in the site.

(Supplement 7)

The conveyance system according to any one of Supplements 1 to 6, in which the travel plan generating unit generates the travel plan for causing the conveyance vehicle to follow or precede the extraneous vehicle on the estimated track on which the extraneous vehicle travels when the extraneous vehicle determining unit determines that the extraneous vehicle is present in the site.

(Supplement 8)

The conveyance system according to any one of Supplements 1 to 7, further including:
a peripheral situation monitoring unit to detect an obstacle around the conveyance vehicle by using sensor information acquired from at least one of an external sensor provided in the conveyance vehicle and a roadside sensor provided in the delivery center; and
a driving control unit to control traveling of the conveyance vehicle using the travel plan generated by the travel plan generating unit and a detection result of the peripheral situation monitoring unit, in which
when the conveyance vehicle continues traveling on a basis of the travel plan generated by the travel plan generating unit and there is a risk of contact with the obstacle detected by the peripheral situation monitoring unit, the driving control unit executes control to avoid contact with the obstacle in preference to the travel plan generated by the travel plan generating unit.

(Supplement 9)

A conveyance vehicle used in the conveyance system according to any one of Supplements 1 to 8, the conveyance vehicle including a driving control unit to execute driving control on a basis of a travel plan generated by a travel plan generating unit included in the conveyance system.

(Supplement 10)

A conveyance system for connecting a conveyance vehicle to a trailer parked in a site of a delivery center and moving the trailer to a warehouse provided in the delivery center or a parking lot of the delivery center by the conveyance vehicle, the conveyance method including:
generating, by a travel plan generating unit, a travel plan of the conveyance vehicle, the travel plan being used to execute conveyance of the trailer from the parking lot to the warehouse by the conveyance vehicle or conveyance of the trailer from the warehouse to the parking lot; and
determining, by an extraneous vehicle determining unit, whether or not an extraneous vehicle is present in the site, in which
the travel plan generating unit generates the travel plan in which the conveyance vehicle does not obstruct traveling of an extraneous vehicle when the extraneous vehicle determining unit determines that the extraneous vehicle is present in the site.

### REFERENCE SIGNS LIST

1: delivery center, 2: roadside sensor, 3: control device, 4: conveyance vehicle, 5: trailer, 6: truck, 11: warehouse, 12: entrance, 13: exit, 14, 14A to B: parking lot, 15, 15A to V: parking space, 16: fence, 17: platform, 18: entrance gate, 19: exit gate, 20: region, 31, 412: map information storing unit, 32: vehicle database, 33: travel plan generating unit (travel plan generator), 34: communication unit, 35: recognition unit, 41: driving control device, 43: steering mechanism, 44: braking/driving mechanism, 45: fifth wheel, 46: lift, 51: king pin, 100: conveyance system, 110a: processing circuit, 110b: processor, 110c: memory, 331: position estimating unit, 332: route determining unit, 333: route following unit, 334: extraneous vehicle determining unit (extraneous vehicle determiner), 411: driving control unit (driving controller), 413: peripheral situation monitoring unit (peripheral situation monitor), 414: GPS receiver, 415: external sensor, 416: peripheral recognition unit, 417: vehicle state acquiring unit, 418: steering angle sensor, 419: vehicle speed sensor, 420: gyro sensor, 421: acceleration sensor, 422: communication bus, 423: in-vehicle communication unit, 424: connection control unit, 431: steering actuator, 441: braking/driving actuator

What is claimed is:

1. A conveyance system for connecting a conveyance vehicle to a trailer parked in a site of a delivery center and for moving by the conveyance vehicle the trailer either to a warehouse provided in the delivery center or to a parking lot of the delivery center, the conveyance system comprising:
a travel plan generator to generate a travel plan of the conveyance vehicle, the travel plan being used to execute conveyance of the trailer by the conveyance vehicle either from the parking lot to the warehouse or from the warehouse to the parking lot; and
an extraneous vehicle determiner to determine whether or not an extraneous vehicle is present in the site, wherein
the travel plan generator, when the extraneous vehicle determiner determines that the extraneous vehicle is present in the site, generates the travel plan such that the conveyance vehicle does not obstruct traveling of the extraneous vehicle.

2. The conveyance system according to claim 1, wherein
the travel plan generator, when the extraneous vehicle determiner determines that the extraneous vehicle is present in the site, generates the travel plan such that the conveyance vehicle stands by at a standby place provided in the site.

3. The conveyance system according to claim 1, wherein
the travel plan generator, when the extraneous vehicle determiner determines that the extraneous vehicle is present in the site, generates the travel plan such that the conveyance vehicle stands by at a place provided in the site, the place being outside of a passage for the extraneous vehicle to travel.

4. The conveyance system according to claim 1, wherein
the travel plan generator estimates an orbital path for the extraneous vehicle to trace, the orbital path being estimated by referring to either a position where the extraneous vehicle parks the trailer or a parking position of the trailer to be towed by the extraneous vehicle.

5. The conveyance system according to claim 4, wherein
the travel plan generator, when the extraneous vehicle determiner determines that the extraneous vehicle is present in the site, generates the travel plan such that entry of the conveyance vehicle into the estimated path for the extraneous vehicle to trace is avoided.

6. The conveyance system according to claim 4, wherein
the travel plan generator, when the extraneous vehicle determiner determines that the extraneous vehicle is present in the site, generates the travel plan such that the conveyance vehicle does not cross the estimated path for the extraneous vehicle to trace.

7. The conveyance system according to claim 4, wherein
the travel plan generator, when the extraneous vehicle determiner determines that the extraneous vehicle is present in the site, generates the travel plan such that the conveyance vehicle follows or precedes the extraneous vehicle on the estimated path for the extraneous vehicle to trace.

8. The conveyance system according to claim 1, further comprising:
a peripheral situation monitor to detect an obstacle around the conveyance vehicle by referring to sensor information acquired from at least one of an external sensor provided in the conveyance vehicle and a roadside sensor provided in the delivery center; and
a driving controller to control traveling of the conveyance vehicle by referring to both the travel plan generated by the travel plan generator and the detection result of the peripheral situation monitor, wherein
the driving controller, when the conveyance vehicle continues traveling by referring to the travel plan generated by the travel plan generator and when there is a risk of contact with the obstacle detected by the peripheral situation monitor, executes control to avoid contact with the obstacle in preference to the travel plan generated by the travel plan generator.

9. The conveyance system according to claim 2, further comprising:
a peripheral situation monitor to detect an obstacle around the conveyance vehicle by referring to sensor information acquired from at least one of an external sensor provided in the conveyance vehicle and a roadside sensor provided in the delivery center; and
a driving controller to control traveling of the conveyance vehicle by referring to both the travel plan generated by the travel plan generator and the detection result of the peripheral situation monitor, wherein
the driving controller, when the conveyance vehicle continues traveling by referring to the travel plan generated by the travel plan generator and when there is a risk of contact with the obstacle detected by the peripheral situation monitor, executes control to avoid contact with the obstacle in preference to the travel plan generated by the travel plan generator.

10. The conveyance system according to claim 3, further comprising:
a peripheral situation monitor to detect an obstacle around the conveyance vehicle by referring to sensor information acquired from at least one of an external sensor provided in the conveyance vehicle and a roadside sensor provided in the delivery center; and
a driving controller to control traveling of the conveyance vehicle by referring to both the travel plan generated by the travel plan generator and the detection result of the peripheral situation monitor, wherein
the driving controller, when the conveyance vehicle continues traveling by referring to the travel plan generated by the travel plan generator and when there is a risk of contact with the obstacle detected by the peripheral situation monitor, executes control to avoid contact with the obstacle in preference to the travel plan generated by the travel plan generator.

11. The conveyance system according to claim 4, further comprising:
a peripheral situation monitor to detect an obstacle around the conveyance vehicle by referring to sensor information acquired from at least one of an external sensor provided in the conveyance vehicle and a roadside sensor provided in the delivery center; and
a driving controller to control traveling of the conveyance vehicle by referring to both the travel plan generated by the travel plan generator and the detection result of the peripheral situation monitor, wherein
the driving controller, when the conveyance vehicle continues traveling by referring to the travel plan generated by the travel plan generator and when there is a risk of contact with the obstacle detected by the peripheral situation monitor, executes control to avoid contact with the obstacle in preference to the travel plan generated by the travel plan generator.

12. The conveyance system according to claim 5, further comprising:
a peripheral situation monitor to detect an obstacle around the conveyance vehicle by referring to sensor information acquired from at least one of an external sensor provided in the conveyance vehicle and a roadside sensor provided in the delivery center; and
a driving controller to control traveling of the conveyance vehicle by referring to both the travel plan generated by the travel plan generator and the detection result of the peripheral situation monitor, wherein
the driving controller, when the conveyance vehicle continues traveling by referring to the travel plan generated by the travel plan generator and when there is a risk of contact with the obstacle detected by the peripheral situation monitor, executes control to avoid contact with the obstacle in preference to the travel plan generated by the travel plan generator.

13. The conveyance system according to claim 6, further comprising:
a peripheral situation monitor to detect an obstacle around the conveyance vehicle by referring to sensor information acquired from at least one of an external sensor provided in the conveyance vehicle and a roadside sensor provided in the delivery center; and
a driving controller to control traveling of the conveyance vehicle by referring to both the travel plan generated by the travel plan generator and the detection result of the peripheral situation monitor, wherein
the driving controller, when the conveyance vehicle continues traveling by referring to the travel plan generated by the travel plan generator and when there is a risk of contact with the obstacle detected by the peripheral situation monitor, executes control to avoid contact with the obstacle in preference to the travel plan generated by the travel plan generator.

14. The conveyance system according to claim 7, further comprising:
a peripheral situation monitor to detect an obstacle around the conveyance vehicle by referring to sensor information acquired from at least one of an external sensor provided in the conveyance vehicle and a roadside sensor provided in the delivery center; and
a driving controller to control traveling of the conveyance vehicle by referring to both the travel plan generated by the travel plan generator and the detection result of the peripheral situation monitor, wherein
the driving controller, when the conveyance vehicle continues traveling by referring to the travel plan generated by the travel plan generator and when there is a risk of contact with the obstacle detected by the peripheral situation monitor, executes control to avoid contact with the obstacle in preference to the travel plan generated by the travel plan generator.

15. A conveyance vehicle used in the conveyance system according to claim 1,
the conveyance vehicle comprising a driving controller to execute driving control by referring to a travel plan generated by a travel plan generator included in the conveyance system.

16. A conveyance method for connecting a conveyance vehicle to a trailer parked in a site of a delivery center and for moving by the conveyance vehicle the trailer either to a warehouse provided in the delivery center or to a parking lot of the delivery center, the conveyance method comprising:
generating, by a travel plan generator, a travel plan of the conveyance vehicle, the travel plan being used to execute conveyance of the trailer by the conveyance vehicle either from the parking lot to the warehouse or from the warehouse to the parking lot; and
determining, by an extraneous vehicle determiner, whether or not an extraneous vehicle is present in the site, wherein
the travel plan generator, when the extraneous vehicle determiner determines that the extraneous vehicle is present in the site, generates the travel plan such that the conveyance vehicle does not obstruct traveling of an extraneous vehicle.
